(19) United States
(12) Patent Application Publication
(10) Pub. No.: US 2005/0268109 A1
(43) Pub. Date: Dec. 1, 2005

(54) Object based communication network

(76) Inventor: Christopher P. McIntosh, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/125,824

(22) Filed: May 9, 2005

Related U.S. Application Data
(60) Provisional application No. 60/569,224, filed on May 7, 2004.

(51) Int. Cl. H04K 1/00

(52) U.S. Cl. 713/182

(57) ABSTRACT

A communications network is described wherein a plurality of devices are assigned unique identifiers and configured to communication with the network, and wherein servers on the edge of the network are configured to control the devices using the unique identifiers. The devices can be controlled according to rules defined by a user, and the devices may be configured to communicate with and control other devices in the network.

### CROSS-REFERENCE TO RELATED APPLICATIONS

This application claims priority to U.S. Provisional Patent Application No. 60/569,224 entitled “INTERNET OPERATING SYSTEM” and filed on May 7, 2004. The disclosure of the above-described application is hereby incorporated by reference in its entirety.

### BACKGROUND OF THE INVENTION

1. Field of the Invention

The present invention relates generally to communication networks, and more particularly to a communication network for communicating with objects having unique identifiers.

2. Description of the Related Art

The use of the Internet and wireless networks have increased exponentially in recent years. This has allowed many new disparate devices to interact and communicate with each other. Unfortunately, current Internet and wireless network solutions lack key components required to allow large numbers of these devices to seamlessly interact with one another. Currently, their are two network models are being used to connect devices: a centralized network architecture (client-server) and a distributed network architecture (peer-to-peer (P2P)).

Centralized network architectures require a central control point to connect devices. This control point runs applications that control and communicate with the connected devices. All of the devices have a standard hardware and software (protocol) interface. This model is good for communication between a single company's devices (Echelon to Echelon, or Phone.com WAP to Phone.com WAP), however, it is impractical for interoperability between different vendors' devices. Moreover, the addition of a new function in any single device requires modification of all the protocols and notification/upgrade to all other possible devices. For this reason, this architecture is good for communications between one company's devices using their own protocols, but poor for inter-vendor communications.

Peer-to-Peer network architectures have no control point and every device communicates with every other device over an open interface. Each computer or device has equivalent capabilities and responsibilities. Thus, the total number of possible links between devices/users is N(N−1)/2. This model is used in the Internet for the Hyper Text Transfer Protocol (HTTP). Examples of distributed peer-to-peer solutions include Microsoft's HailStorm suite (.NET/Passport/DCOM). This architecture is good for communications between generic devices (HTTP) or a small number of similar intelligent applications (XML). However, the P2P architecture is poor for connecting a large number of dissimilar devices because, for example, any peer can go “dark” at any time, there is no easy way to enforce content ownership/copyrights, it is difficult to enforce technical and/or ethical standards any many others. While this architecture is good for communications between a small number of different company's devices, it does not provide for an environment where new device types can be readily introduced and assimilated.

### SUMMARY OF THE INVENTION

One embodiment of the invention is a wide area network for connecting and controlling a plurality of devices. The network includes: a plurality of devices, wherein each device has a unique identifier; at least one edge server configured to communicate with at least one of said plurality of devices and receive said unique identifier; and at least one first virtual registry in communication with said at least one edge server and configured to associate said unique identifier with at least one server, wherein said at least one server stores an instruction file configured for execution on said edge server, wherein execution of said instruction file enables the edge server to control the device.

Another embodiment of the invention is a method of controlling a plurality of devices in a wide area network. This embodiment includes: providing a plurality of devices, wherein each device has a unique identifier; transmitting said unique identifier to an edge server, wherein said edge server is configured to transmit said unique identifier to a virtual registry; determining at least one server comprising an instruction file by using said virtual registry to associate said unique identifier with said server; and transmitting said instruction file to said edge server, wherein said edge server is configured to execute said instruction file and thereby control functions of said device.

Still another embodiment of the invention is a system for controlling a plurality of devices in a wide area network. The system includes: means for providing a plurality of devices, wherein each device has a unique identifier; means for transmitting said unique identifier to an edge server, wherein said edge server is configured to transmit said unique identifier to a virtual registry; means for determining at least one server comprising an instruction file by using said virtual registry to associate said unique identifier with said server; and means for transmitting said instruction file to said edge server, wherein said edge server is configured to execute said instruction file and thereby control functions of said device.

### BRIEF DESCRIPTION OF THE DRAWINGS

FIG. 1 is a block diagram of one embodiment of an Internet Operating System (IOS).

FIG. 2 is a block diagram of a Global Mobility Edge Server (GLOME) of the IOS of FIG. 1.

FIG. 3 is a block diagram of two devices configured to communicate with each other and elements for communication between the devices.

FIG. 4 is a block diagram of the Programmable Object Device (POD) WCP Encoder Decoder and Arbitration Function. This Software Entity can be on an existing hardware component or embedded in a POD as shown in FIG. 3.

FIG. 5 is a block diagram of an Object Global Virtual Registry (O-GVR) that contains records for each POD that is provisioned in the IOS.

FIG. 6 is a block diagram of an Internet Global Virtual Registry (I-GVR) that contains records for each user of the IOS.

FIG. 7 is a block diagram illustrating the contents of one embodiment of an I-GVR Record of the I-GVR of FIG. 6.

FIG. 8 is a block diagram illustrating the contents of one embodiment of an O-GVR List Record of the I-GVR Record of FIG. 7.

FIG. 9 is a block diagram illustrating the contents of one embodiment of the O-GVR Record of the O-GVR of FIG. 5.

FIG. 10 is a block diagram illustrating the contents of one embodiment of the POD Record of the O-GVR Record of FIG. 9.

FIG. 11 is a block diagram illustrating the contents of one embodiment of the I-GVR list record of the O-GVR Record of FIG. 9.

FIG. 12 is a block diagram illustrating the contents of one embodiment of the Device Record of the O-GVR Record of FIG. 9.

FIG. 13 is a block diagram illustrating the relationship between the Internet Operating System and a typical PC-based operating system. The top line of the figure gives the Microsoft Windows® equivalent of the IOS components shown underneath.

FIG. 14 is a block diagram illustrating one embodiment of a Programmable Object Device.

FIG. 15 is a block diagram illustrating the contents of one embodiment of an Internet Object Icon (Io Icon) library, stored at the Io Icon library repository of the IOS of FIG. 1.

FIG. 16 is a block diagram illustrating the contents of one embodiment of a POD identifier, such as the POD identifier of FIG. 9 and FIG. 4

FIG. 17 is a block diagram illustrating the contents of an alternative embodiment of a POD identifier, such as the POD identifier of FIG. 9 and FIG. 4

FIG. 18 is a block diagram illustrating the contents of one embodiment of a Lynx Library, such as the Lynx Library of FIG. 3 used at a Global Mobility Edge Server, and stored at the Lynx Library Repository of the IOS of FIG. 1.

FIG. 19 is a block diagram illustrating the contents of one embodiment of a Device Library, such as the Device library at the GLOME of FIG. 3 and configured for storage at the Device library repository of the IOS of FIG. 1 and for lodging at the library socket of the GLOME of FIG. 2.

FIG. 20 is a block diagram illustrating the contents of one embodiment of a POD Library, such as the POD library at the POD of FIG. 3 and configured for storage at the POD library repository of the IOS of FIG. 1 and for lodging at the POD library socket of the POD of FIG. 4.

FIG. 21 is a block diagram illustrating the contents of one embodiment of an IoConnect Library, such as the IoConnect library at the GLOME of FIG. 34 and configured for storage at the IoConnect library repository of the IOS of FIG. 1 and for lodging at the library socket of the GLOME of FIG. 2.

FIG. 22 is a block diagram illustrating the contents of one embodiment of a message mapping table used by the GLOME of FIG. 2, for example, in receiving or sending a message to a POD or a user.

FIG. 23 is a block diagram illustrating the contents of one embodiment of a Message POD record, such as a Message POD record stored in the message mapping table of FIG. 22.

FIG. 24 is a block diagram illustrating the contents of one embodiment of a Message record, such as a message record stored in the Message POD record of FIG. 23 and the Message User record of FIG. 42.

FIG. 25 is a block diagram illustrating the contents of one embodiment of the device library record stored in the POD record of FIG. 23.

FIG. 26 is a block diagram illustrating the contents of one embodiment of a Wireless Control Protocol Data Message type that is transported in the payload of the Wireless Control Protocol Message of FIG. 40.

FIG. 27 is a flow diagram of the lifecycle of a typical POD as shown in FIG. 3.

FIG. 28 is a message diagram showing how a Web User or automaton would typically set up rules amongst PODs and other users.

FIG. 29 is a message diagram showing an example of a POD interacting with a Web User or automaton.

FIG. 30 is a message diagram showing an example of two PODs interacting.

FIG. 31 is a message diagram showing an example of a Web User or automaton interacting with a POD.

FIG. 32 is a message diagram showing an example of a POD interacting with multiple PODs.

FIG. 33 is a message diagram showing an example of two PODs interacting with a receiving POD that requires input from both PODs before it is contacted.

FIG. 34 is a block diagram of an IOS user using an object browser via a standard web browser.

FIG. 35 is a block diagram of an IOS user using an object browser via object browser client software on their PC.

FIG. 36 is a block diagram of a MicroPOD type POD.

FIG. 37 is a block diagram illustrating the contents of one embodiment of a result message that is sent between GLOMES as shown in FIG. 1.

FIG. 38 is a block diagram illustrating the contents of one embodiment of a Wireless Control Protocol Trigger Message type that is transported in the payload of the Wireless Control Protocol Message of FIG. 40.

FIG. 39 is a block diagram illustrating the contents of one embodiment of a Wireless Control Protocol Software Message type that is transported in the payload of the Wireless Control Protocol Message of FIG. 40.

FIG. 40 is a block diagram illustrating the contents of one embodiment of a Wireless Control Protocol Message that is sent and received between GLOMES and PODs.

FIG. 41 is a block diagram illustrating the contents of one embodiment of an IOS User Record contained in the Massage Mapping Table of FIG. 22.

FIG. 42 is a block diagram illustrating the contents of one embodiment of an MSG User Record contained in the Massage Mapping Table of FIG. 22.

FIG. 43 is a block diagram illustrating the contents of one embodiment of an IOS POD Record contained in the Massage Mapping Table of FIG. 22.

### DETAILED DESCRIPTION OF CERTAIN INVENTIVE EMBODIMENTS

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Embodiments of the invention relate to a distributed system, termed herein, and “Internet Operating System” for connecting, or communicating with, a plurality of devices using a set of predefined rules contained in dynamic libraries. In one embodiment, each device uses a unique identifier to connect to an “edge server” which provides access into a trusted domain of the system. Within the trusted domain is a central registry that is configured to connect the edge server to a repository of software that is unique to each type, or manufacturer, of device. For example, if the device is a Toshiba® Model 123 video recorder, the central registry will connect the video recorder to software that is specific that particular model and brand of video recorder. The software can then be downloaded as an instruction file to the edge server and used to update or configure the video recorder. In one embodiment, the software is a set of macro-like instructions that are compiled in real-time on the edge server and then used to update or configure the video recorder. As can be envisioned, such a system allows a wide variety of devices, from a wide variety of vendors to be efficiently controlled.

Embodiments of the invention also relate to an Internet Operating System that is configured to define trigger rules and responses in a plurality of devices. The trigger rules are run in response to an event being triggered with a device while a the responses define the proper action to take once the event has been triggered. The IOS also is configured to allow users to store and manipulate a set of rules relating the interactions between various devices using a set of predefined, or user defined, rules contained in dynamic libraries. In one embodiment, each device uses a unique identifier to connect to an “edge server” which provides access into a trusted domain of the system. Within the trusted domain is a central registry that is configured to allow the edge server to download software from a repository of software that is unique to each type, or manufacturer, of device and to download execution logic that specifies a set of rules amongst the devices. For example, if one device is a Toshiba® Model 123 video recorder, and another device is a Mitsubishi® Model 321 video recorder the central registry will identify the proper software to download to the edge servers to expose each video recorder to other users and devices registered in the IOS. Authorized users or other devices in the system can then specify interaction rules for dynamic links between the devices and also specify the events that will trigger the interactions and the device's responses to the interactions. Once the rules are defined, the devices are capable of autonomously interacting with one another without human intervention.

In one embodiment, the software is a set of macro-like instructions that are compiled in real-time on the edge server when a trigger occurs to execute rules allowing interaction between the video recorders. Interaction rules can be specified between devices and other devices, or between devices and users, or between users and users. Users can be humans, or software application programs such as Inventory systems or customer resource systems. As can be envisioned, such a system allows a wide variety of devices, from a wide variety of vendors to efficiently and autonomously interact.

In one embodiment, a user can store their own software instructions that can be used to define the interactions between devices that they own. For example, a user may log into the system and store commands that instruct the video recorder to send the user an email indicating that the recorder has started to record a program. The user would log into the system and use a user interface to store commands that would autonomously detect when the video recorder had started to record a program, and then send an email to a particular email address in response. This software would be dynamically be downloaded to the edge server that was attached to the video recorder. This and other embodiments of the system will be described in more detail below.

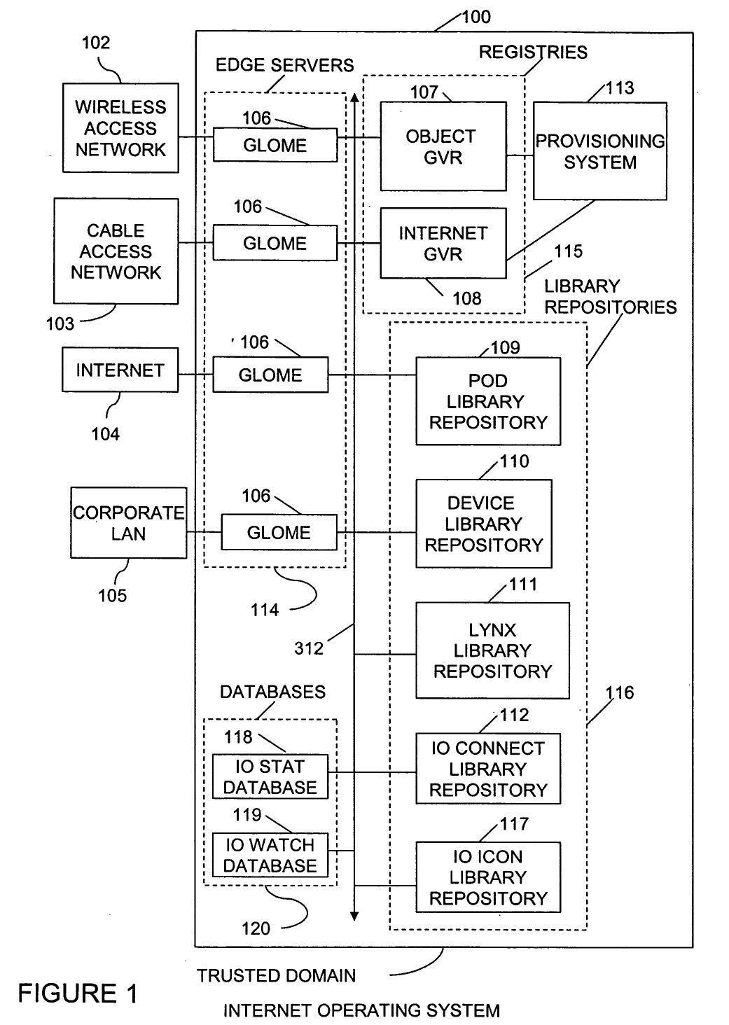

FIG. 1 is a block diagram of one embodiment of an Internet Operating System 100. The Internet Operating System (IOS) may be offered by an IOS service provider who owns the equipment 100 illustrated in FIG. 1. The IOS service provider can sign-up a plurality of individual users, manufacturers, and businesses to use the IOS 100. These users can have accounts for individual human users, external application programs, such as Customer Resource Management systems and Point of Sales systems, and physical devices such as automobiles, stereos, and alarm systems. In one embodiment, before users can use the IOS 100, they must have an account created for them by the operator of the IOS 100. The system can then be used to efficiently connect the users to any or all of their devices.

The Internet Operating System (IOS) 100 is preferably a trusted domain with a plurality of Global Mobility Edge Servers (GLOMEs) 114 at its edge, wherein users and devices interface with the IOS 100 through an individual GLOME 106. Each GLOME 106 communicates with each other and other elements of the IOS 100 using an internal bus 312. The GLOMEs range from large systems (GLOME Switches) for use in metropolitan areas to small systems, such as GLOME HUBS deployed in a small office. In one embodiment, the functionality of the GLOMEs is the same no matter what their size is. The type of access a user makes to the GLOMEs 106 may depend on the type of user. Certain users may interface with a GLOME using HTTP or wireless protocols such as WAP, SMS and MMS. They may also interact with the GLOMEs using XML based languages, such as VoiceXML which originates from an Intelligent Voice Recognition System. External application programs may interface with the IOS 100 through a GLOME that supports XML and BPEL based protocols. Devices interact with the IOS 100 via programmable object devices (PODs) that are stored on the device. Devices can also interact with GLOMES using a remote Software Entity, wherein they connect into a GLOME through another device.

The GLOMEs 106 connect with external networks such as Wireless Access Networks 102, Cable Access Networks 103, Corporate LANs 105 and the Internet 143 using protocols such as TCP/IP and SMS. The GLOMEs 114 are connected to multiple entities within the IOS 100, including a Global Virtual Registry 115 which comprises an Object Global Virtual Registry 107 and Internet Global Virtual Registry 108. The Global Virtual Registry 115 is configured to store information for all of the users and devices in communication with the IOS 100. Of course, it should be realized that many different Global Virtual Registries could be used within the system as well as stand alone Object Global Virtual Registries 107 and Internet Global Virtual Registries 108. New Object Entries for objects new to the IOS 100, and new user entries for users that are new to the IOS 100, are created in the object global virtual Registry 107 and the Internet global virtual registry 108, respectively, using a Provisioning System 113. The provisioning system 113 includes the software and data storage required to load and maintain new users within the system 100.

The GLOMEs 106 are also in communication with multiple Library Repositories 116, including a POD Library Repository 109, a Device Library Repository 110, a Lynx Library Repository 111, an Internet Object Icon Library Repository 117, and an Internet Object connection library repository 112. The Library Repository 116 can be a series of repositories that are physically located in separate geographic locations.

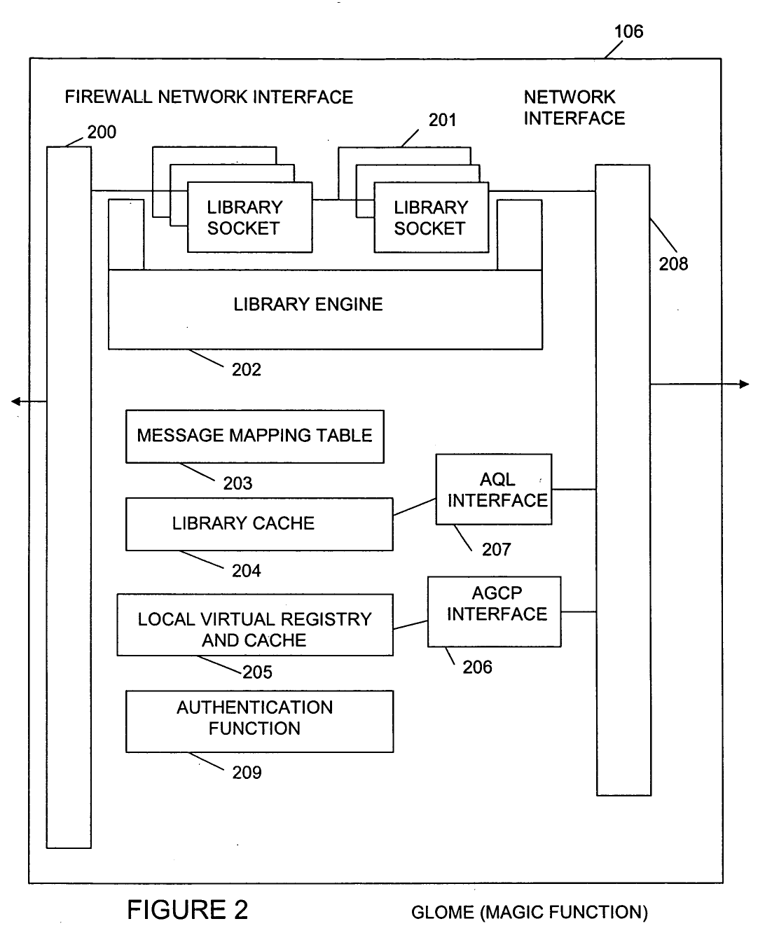

FIG. 2 is a block diagram of one embodiment of the GLOME 106. The GLOME comprises a firewall and network interface 200 configured to interface with external networks, such as the networks 102-105 illustrated in FIG. 1. The GLOME 106 comprises library sockets 201 for dynamically hosting library execution logic that is retrieved from the library repositories 116 (FIG. 1) and stored in a library cache 204. In one embodiment, an Application Query Language module 207 is configured to retrieve the execution logic through a network interface 208. The GLOME 106 further comprises a library engine 106 configured to execute the retrieved execution logic. An authentication function 209 ensures that all communications are secure between the GLOME and any external devices.

The GLOME 106 also comprises a Local Virtual Registry module 205 configured to cache recent results from global virtual registry queries and cache transient data associated with individual transactions, wherein the global virtual registry queries are performed by an Application Gateway Control Protocol (AGCP) module 206 configured to use AGCP to query the global virtual registries 115. The network interface 208 is configured to facilitate communication with the library repositories 116 and Global Virtual Registries 115, and may be based on standard TCP/IP, for example.

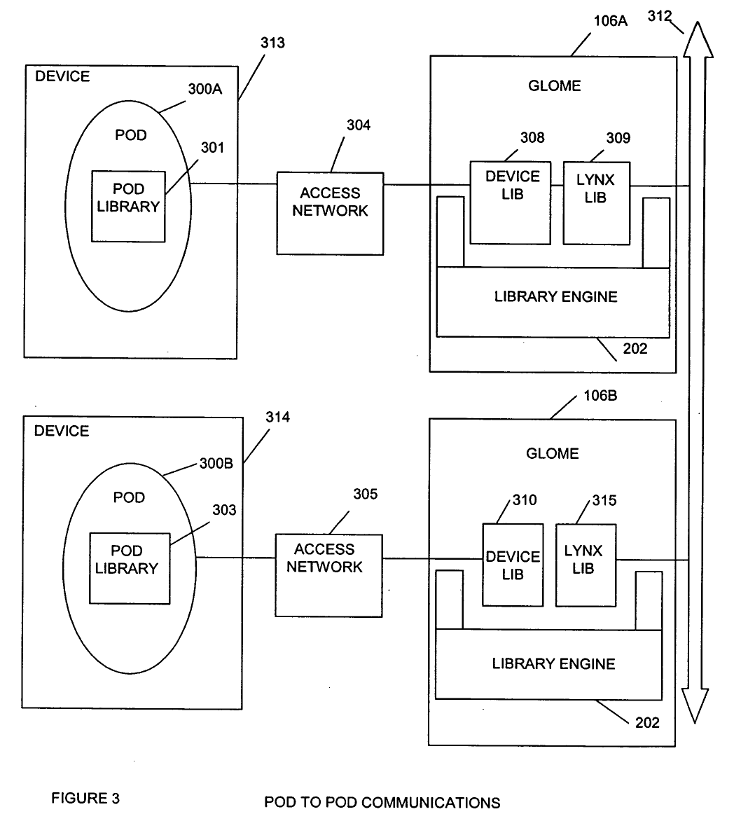

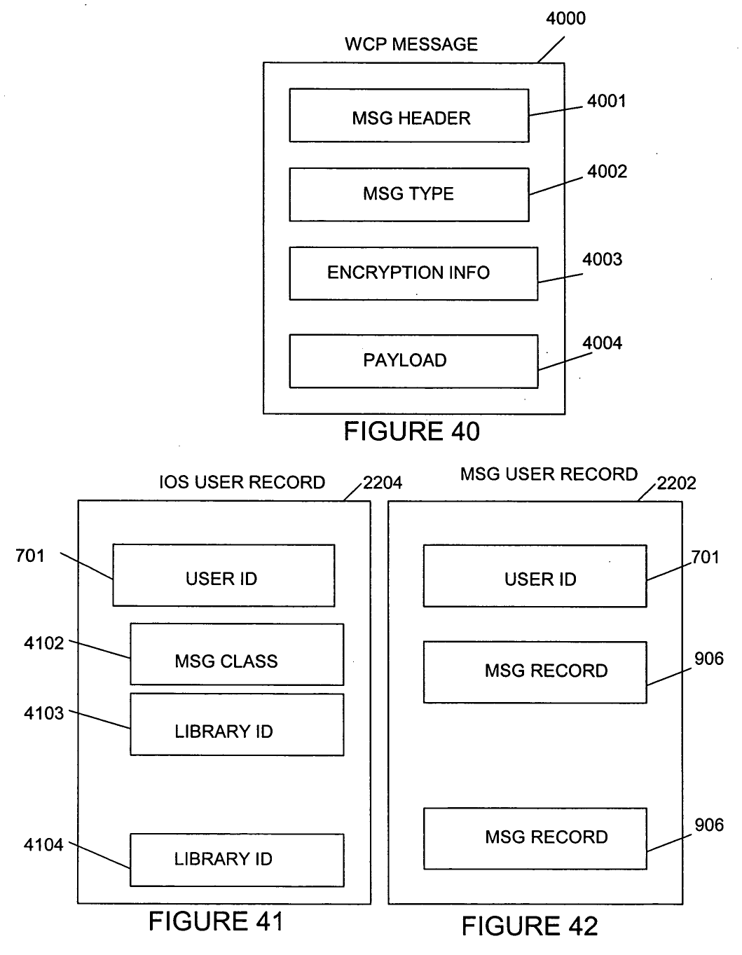

FIG. 3 is a block diagram of a first device 313 configured to interact with a second device 314 using the IOS 100. The devices 313, 314 may be physical objects such as cars or television sets or software entities such as licensed client software. The devices 313, 314 have programmable object devices (PODs) 300A, B or client software imbedded in them, or attached to them. The PODs 300 are provisioned in the IOS 100 after they are manufactured using the provisioning system 113 (FIG. 1). The provisioning of a POD 300 is discussed in more detail below. Each POD 300 contains a POD Library 301, 303 dynamically configured to notify the IOS when certain conditions are met based on signals generated in the devices 313, 314 and dynamically configured to accept controls and updates from the IOS. In one embodiment, the IOS is notified via Wireless Control Protocol (WCP) messages 4000 as shown in FIG. 40 that are passed over an access network 304, 305, such as a wireless network or the Internet, to a GLOME 106A, B.

When Device 313 generates a message via POD 300A, the GLOME 106A interprets the messages by looking in its message Mapping Table 203 for the POD Identifier 401 and Message Number 2401 and dynamically places the proper libraries 308, 309 to be used in its Library Execution Engine 202. The Libraries 308, 309 contain execution logic that is used to process the message sent from the device 313. The libraries 308, 309 are lodged at the library socket 201 of the GLOME 106, as illustrated in FIG. 2. Referring back to FIG. 3, the GLOME 106 A dynamically loads the Device and Lynx Libraries 308, 309 into the library engine 202, and the library engine 202 uses the library execution logic 308, 309 to convert the received messages to a standard result that is sent in the Message Data 3705 field of a Result message 3700 for transmission over the internal bus 312 of the IOS 100 to GLOME 106 B based on the Destination POD ID 2404. When GLOME 106B receives the Result Message 3700 it checks its Message Mapping Table 203 to load the correct Lynx Libraries 315 and Device Library 310 into its Library Engine 202. The Library Engine 202 is then run to execute the Library Logic 310 and 315 on the Message Data 3705 of the Result Message 3700 and the results are forwarded to the POD 300B over the Access Network 305. The GLOMES 106 A,B may contain cached copies of the Libraries 308, 309, 310, 315 and will query Library Repositories if they do not have the Library cached.

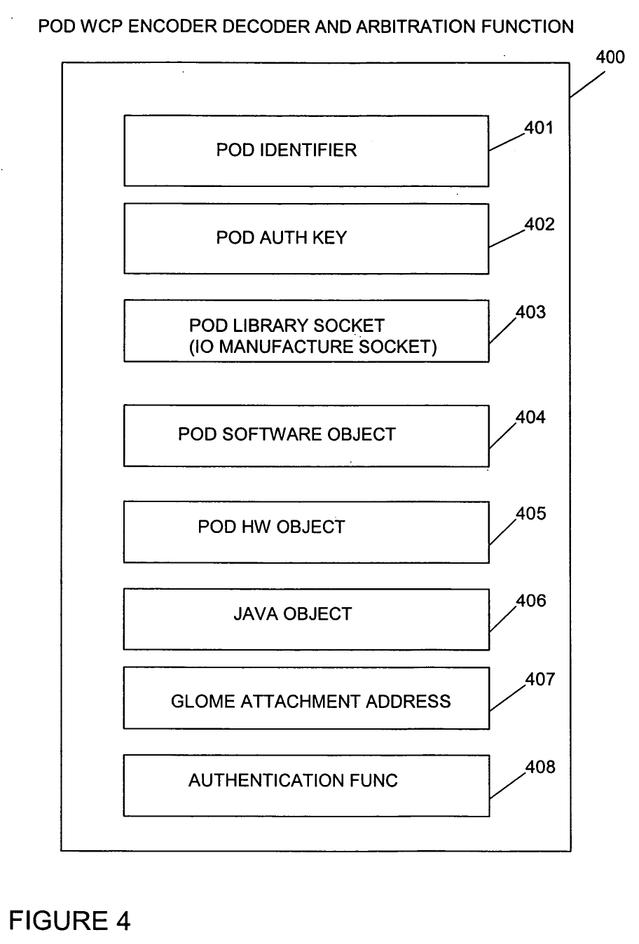

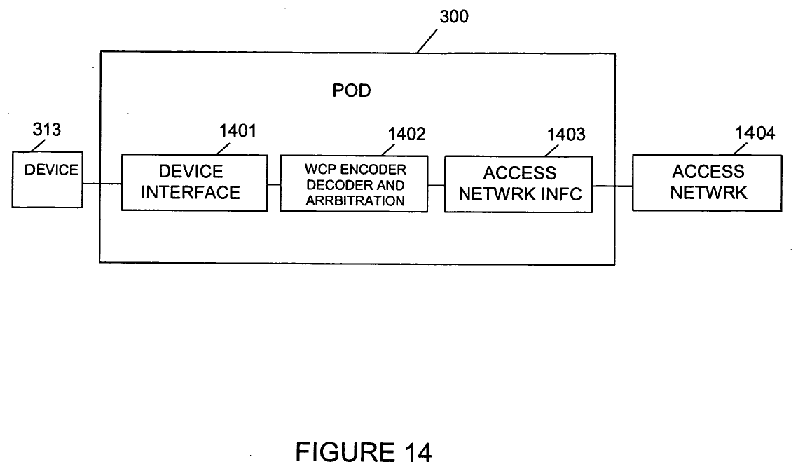

FIG. 4 is a block diagram of one embodiment of the contents of the POD WCP Encoder Decoder and Arbitration Function 400. A detailed block diagram of the POD 300 and its functional components is illustrated in FIG. 14 and discussed in more detail hereinafter. In reference to FIG. 4, the POD WCP Encoder Decoder and Arbitration Function 400 comprises a unique POD identifier 401 and a unique Authentication Key 402, both of which are also stored at the Object Global Virtual Registry 107 in order to uniquely identify the associations between the POD, the device 313, 314 that the POD is embedded in and the libraries relevant to its operation. The function 400 also provides very strong encryption and authentication between the POD and IOS over the untrusted domain. The POD WCP Encoder Decoder and Arbitration Function 400 also comprises a POD Library Socket 403 configured to store execution logic in the form of a POD library downloaded from the POD Library repository 109. In one embodiment of the POD WCP Encoder Decoder and Arbitration Function 400, the library socket 403 may be initially empty immediately following manufacture. The POD WCP Encoder Decoder and Arbitration Function 400 also includes a POD Software object 404 that contains a basic bootstrap program and software kernel to allow the POD to communicate with a GLOME attachment point, and a POD Hardware Object 405 that is unique to the device controller the POD is configured to emulate. In one embodiment, the POD Software Object 404 will contain one or more of the following sub-objects: a bootstrap WCP Kernel, an empty root of downloadable Microprocessor Program Code, an entry point of the device the POD is emulating and Software Interrupt tables of the device the POD is emulating. In one embodiment, the POD Hardware Object 405 contains one or more of the following sub-objects: one Port Object for each hardware port of the device the POD is emulating, a Timer Object for each internal timer of the device the POD is emulating and Register Objects for each internal register of the device the POD is emulating.

The illustrated POD WCP Encoder Decoder and Arbitration Function 400 further comprises a GLOME attachment address field 407 configured to store an initial address for the GLOME 106 the POD 300 will attach to or communicate with when it is first activated. The POD WCP Encoder Decoder and Arbitration Function 400 also includes an authentication function 408, configured to correspond with the authentication function 209 at the GLOME 106 with which the POD will attach to or communicate. The POD WCP Encoder Decoder and Arbitration Function 400 can also include a JAVA object 406 which will allow additional software to be loaded on the POD to augment the existing POD software that was designed for the standard off-the-shelf controller the Pod is emulating.

In one embodiment, the JAVA Object 406 dynamically converts a POD into an Intelligent POD (IntelliPOD) allowing the POD to be proactive and enabling it to plan ahead and take initiative rather than waiting to be instructed what to do. It can also detect favorable situations that serve the devices goal and inform the GLOME 106 server when they occur. In one embodiment, the JAVA Object 406 also allows the IntelliPOD to be responsive to changing circumstances enabling it to be aware of its environment, and functioning appropriately and in a timely manner when encountering exceptional circumstances.

In another embodiment, the JAVA Object 406 also allows the IntelliPOD to be trainable, giving it the ability to modify its future behavior based on past executions, so improving its effectiveness over time. For example, the IntelliPOD may learn a vending machines usage pattern and modify how often it creates and sends reports to focus on busy times thus improving its level of support for monitoring the vending machine. In another embodiment, the JAVA Object 406 can allow the IntelliPOD to be capable of building dynamic relationships thereby allowing it to interact with other IntelliPODs in a very flexible manner. The also allows IntelliPODs to dynamically set up rules by posing as an IOS user. The interfaces and relationships among IntelliPODs need not be fixed, but can change dynamically just as the tasks and business driver's change. IntelliPODs can form temporary groups in order to co-operate to achieve a task or solve a problem. The interfaces, terms and conditions among these IntelliPODs can be negotiated dynamically. IntelliPODs can interact directly with one another via WCP over standard Internet Protocol (IP) communications. These IntelliPOD embodiments can be used individually or in conjunction within a POD.

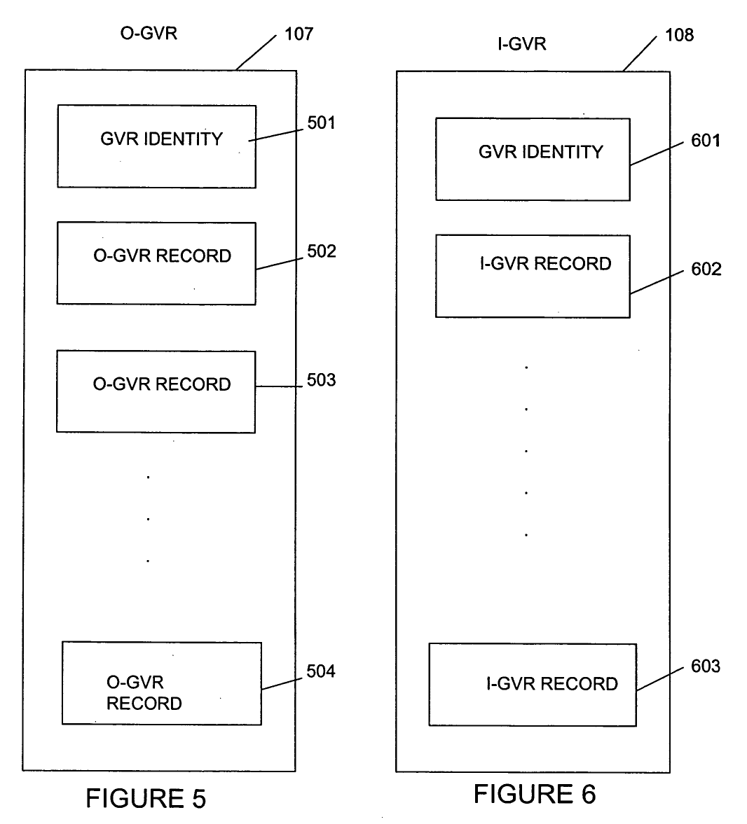

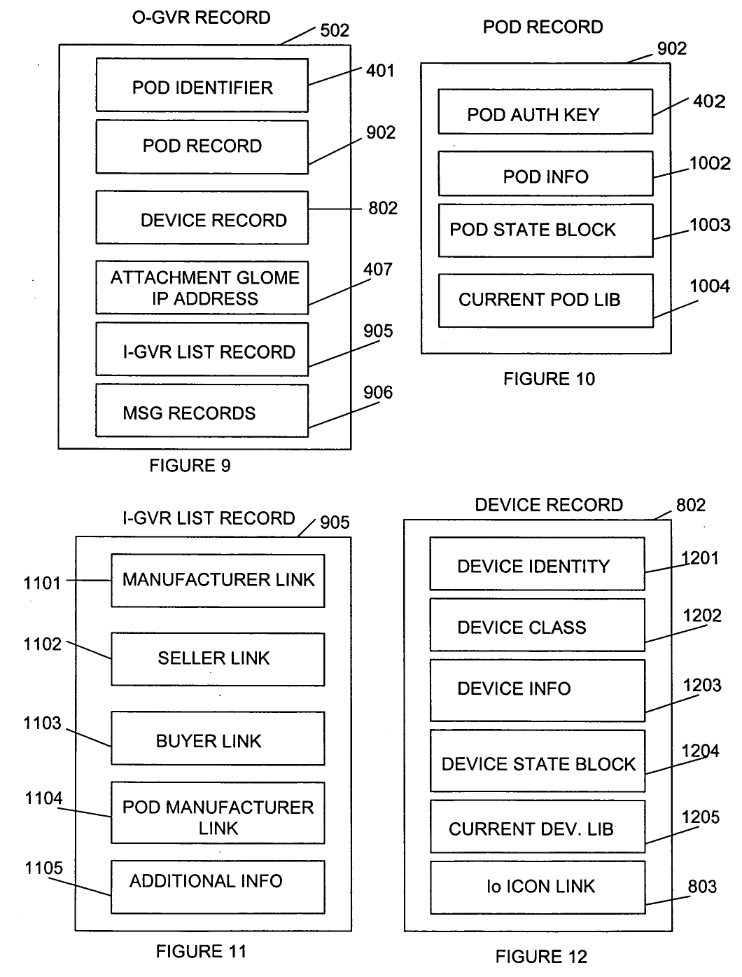

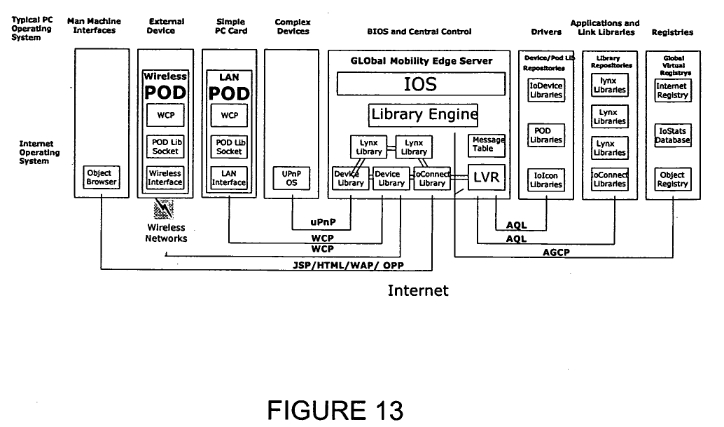

The unique identity information 401, 402 for each POD 300 is also stored at the Object global Virtual Registry 107. FIG. 5 is a block diagram illustrating the contents of one embodiment of the Object Global Virtual Registry (O-GVR) 107. The O-GVR 107 comprises a GVR Identity 501 that uniquely identifies the O-GVR 107, and may comprise an IP address, for example. The O-GVR 107 also comprises a plurality of O-GVR Records 502-504, one for each POD 300 that is provisioned in the IOS 100. The contents of the O-GVR record 502-504 will be discussed in more detail in reference to FIG. 9.

As discussed above, users such as individuals and business processes can access POD enabled devices over the IOS 100. Information identifying and relating to these users is stored in the Internet Global Virtual Registry (I-GVR) 108 (FIG. 1). FIG. 6 is a block diagram illustrating the contents of one embodiment of the I-GVR 108, which includes a GVR Identity 601 that uniquely identifies the registry in the communications network. Similar to the GVR Identity 501 at the O-GVR 107, the GVR identity 108 at the I-GVR 108 may be an IP address. The I-GVR 108 further comprises an I-GVR Record 602-603 for each user of the IOS 100.

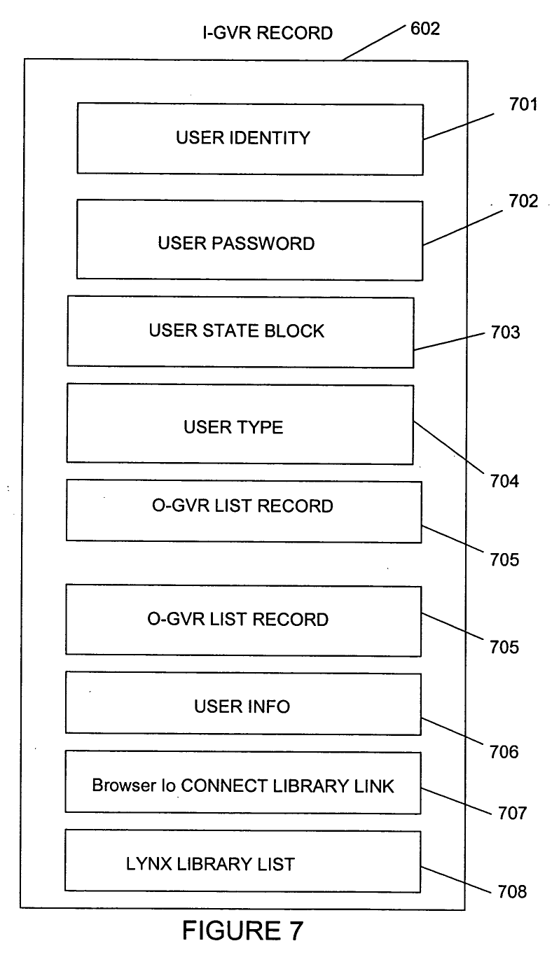

FIG. 7 is a block diagram illustrating the contents of one embodiment of an I-GVR Record. Each I-GVR record has a unique user identity that is used as the record Key. This user identity may be based on the name of the user or external application program, for example. The I-GVR record also contains a user password 702 for authentication when the user logs into the IOS. A User State Block 703 contains the State of the user. Users can be subscribed or unsubscribed. They can also be active or inactive. Option flags are also contained within the User State Block. The type of User 704 is contained in the User Type block. Users can be Manufacturers, Sellers, Buyers, Inventory or Custom. Unique user info 706 can be stored in the record. This information may include the users name, address and telephone number. Each user has one or more POD enabled devices with which they can interact. The list of these accessible PODs is contained in the O-GVR List Record 800. The I-GVR Record 602 further includes IoConnect Library links 707 which contain the links to IoConnect Library Repositories and the unique IoConnect Library ID for the IoConnect libraries the user is entitled to use. These IoConnect libraries contain link/communication logic for providing the user with an interface to communicate with the IOS 100 and are dynamically loaded into the GLOME when they log into it. In one embodiment, the IoConnect library for the user is an Object Browser, as described more completely below. Unique interaction logic that a user defines for autonomous interactions between their POD enabled devices, other users, and themselves is contained in Lynx libraries that are defined by the user using an object browser and stored in Lynx Library Repositories 111. The Links and Library IDs of the users Lynx Libraries are stored in the Lynx Library List 708. Publicly available Lynx Library links and Library Ids are also stored here.

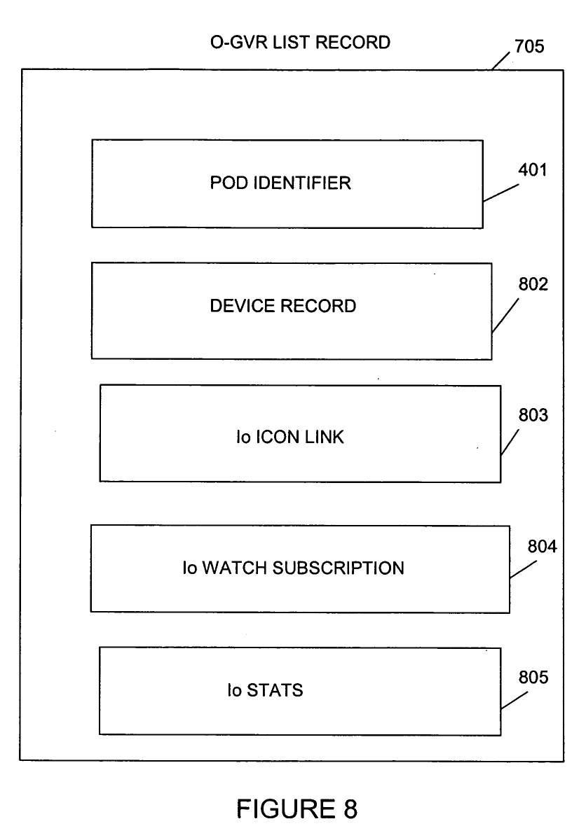

FIG. 8 shows the contents of the O-GVR List Record 800. Each O-GVR List Record contains the unique POD Identifier 801 for the POD it describes. The O-GVR List Record also contains a Device Record 802 that contains information on the device the POD is deployed in and deployed in the POD it is referencing 802 and a link to the proper IoIcon library 803 for displaying a graphical representation of the device, such as an icon, in the Object Browser. Users can subscribe to get notification of changes in the state of the POD using the IoWatch Subscription function 804. If a user wants to collect statistics on a Device with a POD in it, this information is stored in the IoStats field 805.

Each POD in the IOS has a unique record in the O-GVR. These records are shown in FIG. 9. Each O-GVR record 900 has a POD Identifier 401 that is used as the key in the registry. The O-GVR record also contains a POD Record 902 that contains information on the POD. Since each POD is embedded in a Device, information on the Device that the POD is bound with is contained in the Device Record 802. Each POD is connected to a GLOME through an Access Network. The IP address of the GLOME that the POD is attached to is contained in the Attachment GLOME IP Address 407. Each POD can have one or more Users that is can interact with. These users are stored in the I-GVR List record. The O-GVR also contains a list of all of the possible trigger message numbers that a POD can currently generate. The message records contain the composition rules for the libraries needed when a message is processed by a GLOME. FIG. 24 gives more details of the Message Records 906.

FIG. 10 is a block diagram illustrating the contents of one embodiment of the POD Record, wherein each O-GVR Record contains one POD Record 1000. This Record contains the POD Authentication Key 1001 that is the same as the Key contained in the POD 402. Information on the POD such as its Hardware and Software Version are stored in the POD Info field 1002. the state of the POD is stored in the POD State block 1003. POD states include active and inactive. The Library ID 2001 of the POD library that is currently loaded in the POD is stored in the Current POD Lib field 1004.

FIG. 11 shows the contents of the I-GVR list record. Each user that can change a PODs triggers or monitor its functions has a link in the I-GVR list record. The I-GVR list Record contains links to the I-GVR records for the Manufacturer, Seller, Buyer and any other users that will interact with the POD.

FIG. 12 shows the Device record 1200. Each POD is embedded in a device and this record contains information on the device. In one embodiment, there is one Device record in each O-GVR Record. The Device Record contains a unique Device Identity 1201. The class of device is stored in the Device Class field 1202. Each device can be put in a device class. Examples of device classes include: a Toshiba® Model 123 Video Recorder, an automobile, a stereo, a DVD player, etc. Device classes are used to ensure that the proper Lynx library is used with a device. Additional device information can be stored in the Device Info field 1203. This information may comprise the device model number, manufacturer, and unique device serial number. The device state block 1204 contains the state of the device. A device can be active or inactive. The owner state of the device is also contained here. Owner states include Manufacturer, Inventory, Seller, Buyer and Customer. A link to the Device Library Repository and the Library ID 1901 of the current Device library for the device is contained in the Current Device Library field 1205. A Link to the proper IoIcon library for the device is contained in 1206 to allow proper graphical rendering of the device in the Object Browser.

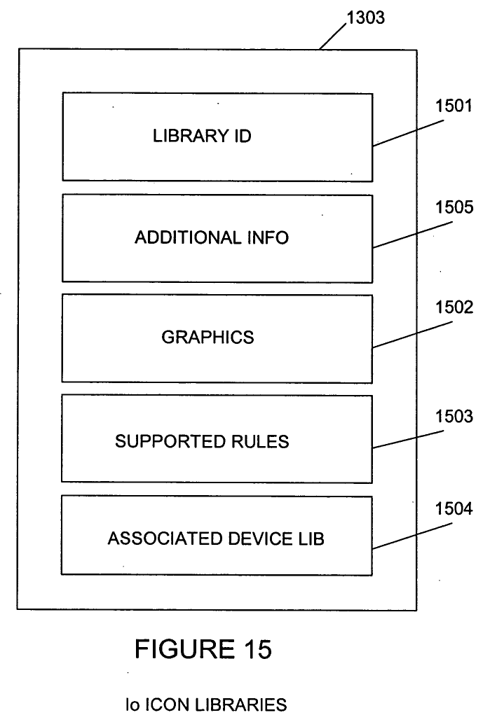

FIG. 15 is a block diagram of typical embodiment of an IoIcon library. Each IoIcon library 1500 has a unique IoIcon Library ID 1501 and is associated with a unique device type. For example a Toshiba® Model 123 Video Recorder. The IoIcon Library also contains graphics 1502 that visually represent the controls, indicators and functions of the device. In one embodiment, the graphics are actual pictures of the device's control panels. The rules for each of the device's controls, indicators and functions depicted in the Graphics 1502 are contained in the Supported Rules 1503. Examples of rules include ranges for controls and possible states for indicators. The rules are specified using standard industry modeling languages. Since each IoIcon Library is associated with a specific device, the link to the associated device library 1900 and its library ID 1901 are stored in 1504.

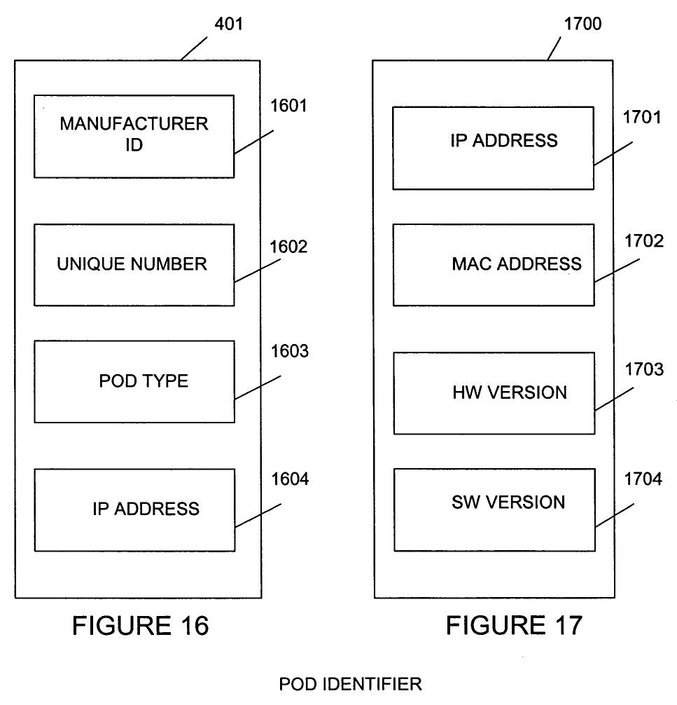

FIG. 16 is a block diagram of one embodiment of a POD Identifier. The POD identifier consists of a Manufacturer ID 1601 that is unique to each POD manufacturer. Every POD has a unique number that is contained in 1602. No two PODs from the same manufacturer typically have the same unique number. Therefore 1601 and 1602 together should be unique to every POD manufactured. The type of POD and additional information on the POD is contained in 1603. POD types can be software, rPOD, MicroPODs or IntelliPods. The POD Type 103 can contain one or more of the following sub-objects, Hardware Version of the POD, Software Version of the Factory Provided Kernel, Memory Size built in from factory, RF Frequency Capability of the POD for a wireless POD, Air Interface Standard for a wireless POD, the MicroPOD microcontroller emulation type, and POD Access Options. A unique IP address of the POD may be stored in 1604 but is not required. Consumer Software such as Music or downloaded Software can be treated as a POD. In this case the POD type is software and the unique number is the software serial number.

FIG. 17 is a block diagram of another embodiment of a POD Identifier based on IP addresses. In one embodiment, this identifier is used for virtual PODs which are Software Entities that appear as PODs. The POD identifier consists of a unique IP Address 1701 and a MAC address 1702. No two PODs from the same manufacturer can ever have the same MAC Address. Therefore 1701 and 1702 together will be unique to every POD manufactured. The Hardware Version of the POD is contained in 1703 and Software Version is stored in 1704.

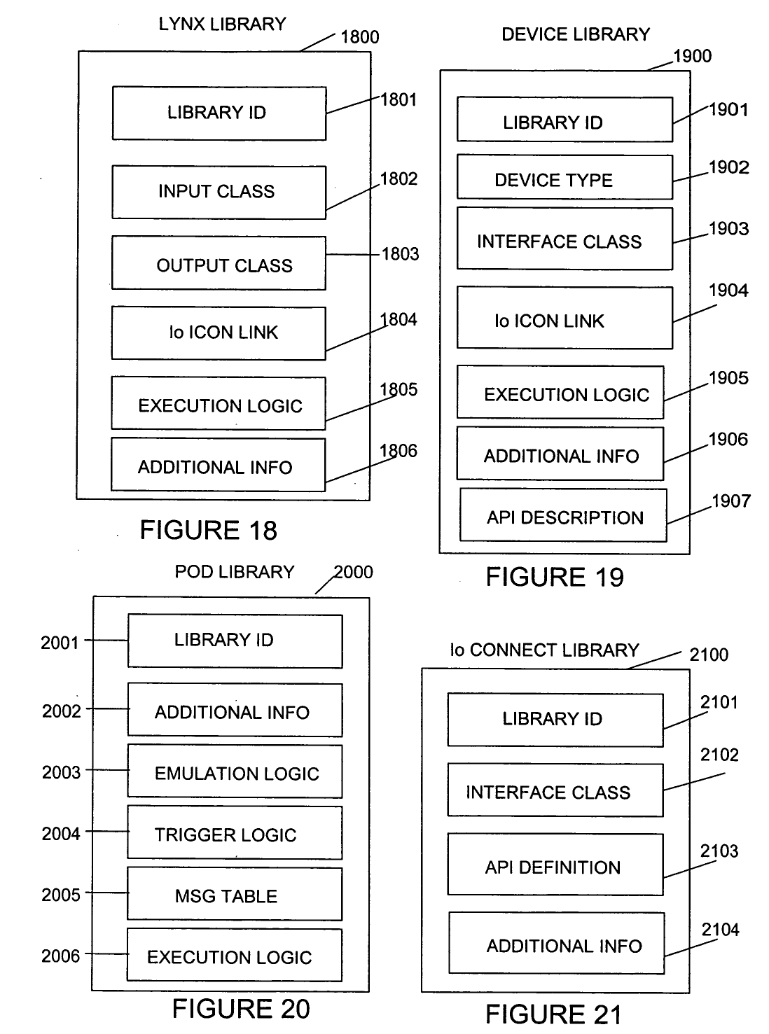

FIG. 18 is a block diagram of an embodiment of a Lynx Library 1800 that is stored in a Lynx Library Repository 111 and downloaded to a GLOMEs 106 library socket 201 when needed for execution in the GLOMES library engine 202. A unique Library Identifier 1801 is associated with each Lynx Library. Lynx libraries will link various devices and user together. The Input Class 1802 and Output Class 1803 define the Device Class of the input and output of the Lynx Library. These Device Classes should match the Device Class 1202 specified in the Device Record 1200 of a device if the Lynx Library is used to interface with a device or the Device Classes should be the same as the Input Device Class and Output Device class of another Lynx Library if the Lynx Library is connecting to another Lynx Library. The IoIcon Library Link and IoIcon Library ID 1501 associated with the Lynx Library is contained in 1804 to allow proper graphical rendering of the Lynx Library in an Object Browser. The execution logic for the Lyn Library is contained in 1805. This logic can consist of source code such as XML or BPEL, or object code and is run in the Library Engine 202 of a GLOME 106. Additional info such as the Libraries version and APIs is contained in the additional info field 1806.

FIG. 19 is a block diagram of an embodiment of a Device Library 1900 stored in a Device Library Repository 110 and downloaded to a GLOMEs 106 library socket 201 when needed for execution in the GLOMES library engine 202. A unique Library Identifier 1901 is associated with each Device Library. Device Libraries are associated with specific Device Types and IoIcon Libraries. The Device type is stored in 1902 and the IoIcon Library Link and IoIcon Library ID 1501 associated with the Device Library is contained in 1904 to allow proper graphical rendering of the Device Library in an Object Browser. The execution logic for the Device Library is contained in 1905. This logic can consist of source code such as XML or BPEL, or object code and is run in the Library Engine 202 of a GLOME 106. Additional info such as the Libraries version and APIs is contained in the additional info field 1906. The interface classes of the Device Library are contained in 1903 while an API description is contained in 1907. These are used by the Object Browser to help in creating new rules.

FIG. 20 is a block diagram of an embodiment of a POD Library 2000 stored in a POD Library Repository 109 and downloaded to a POD's 300 library socket 403. A unique Library Identifier 2001 is associated with each POD Library. Additional Information on the POD Libraries version and interfaces is stored in 2002. Emulation Logic for the POD is stored in 2003 to allow enhanced emulation in the POD. Core trigger logic is contained in 2004. This trigger logic interprets the Rules and Software 3803 passed in the WCP Trigger Messages 3800 and sets and resets internal triggers in the POD. The MSG table 2005 function maps the trigger logic rules to the message numbers 3802 passed in the WCP Trigger Messages 3800. Additional execution logic is contained in 2006 and is typically object code.

FIG. 21 is a block diagram of an embodiment of a IoConnect Library 2100 stored in a IoConnect Library Repository 112 and downloaded to a GLOMEs 106 library socket 201 when needed for execution in the GLOMES library engine 202. The IoConnect Library contains the Logic to allow a user or external software program to interface with the IOS. An example of an IoConnect Library is a WAP based object browser for a cell phone. A unique Library Identifier 2101 is typically associated with each IoConnect Library. The Interface class of the IoConnect Library is contained in 2103. This should match the Input 1803 or Output Class 1804 of the Lynx libraries it can be composed with. The API definitions are contained in 2103. Additional info such as the type of user is included in 2104. Examples of user types are HTTP for web users, WAP for cell phone users and XML for external software programs.

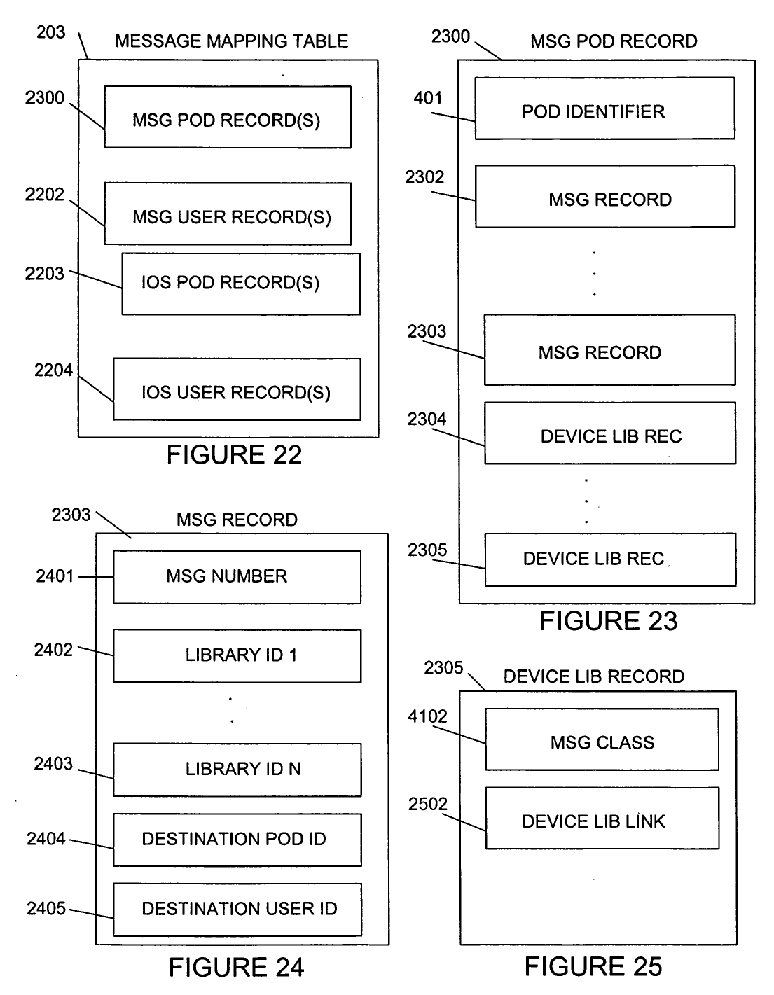

FIG. 22 is a block diagram of an embodiment of the message Mapping Table 203 in a GLOME 106. After a user generates new rules and trigger conditions in an Object Browser, the browser stores the rules in a new Lynx Library, updates the trigger rules in all of the relevant PODs 300 using WCP Trigger Messages 3800 and generates a new Message Record 906 with a new incremental Message Number 2401 for each affected POD.

When a trigger condition occurs in one of the PODs 300, it generates a WCP Data Message 2600 containing the Message Number 2401 and its unique POD Identifier 401. The Message Record 906 contains the composition of the libraries needed to process the message and is stored in the GLOME 106 Message Mapping Table 203.

When the GLOME 106 receives a WCP Trigger Message 3800 it searches the MSG POD Records 2300 in the Message Mapping Table 203 based on the POD Identifier 401. When the MSG POD Record 2300 is found, the Message Record 906 is searched for the matching Message Number 2401. When the proper MSG Record 906 is found, the GLOME 106 knows which libraries to fetch to run in its Library Engine 202.

A user can also generate an incoming message. The GLOME 106 then searches the MSG User Records 2202 in its message Mapping Table 203 based on the User Identifier 701. When the matching MSG User Record 2202 is found, the Message Records 906 are searched for the matching Message Number 2401. When the proper MSG Record 906 is found, the GLOME 106 knows which libraries to fetch to run in its Library Engine 202. Messages can also enter the GLOME from the IOS for delivery to PODs or users.

When a GLOME receives an incoming Result Message 3700 message from the internal IOS Bus 312 it checks the POD Identifier 3702 field for a non-null and valid Pod Identifier 401. If the POD Identifier is valid and non-null, the GLOME searches the IOS POD Records 2203 in its message Mapping Table 203 based on the POD Identifier 401. When the matching IOS POD Record 2203 is found, the Message Class List 4302 is searched using the Message Class 3704 from the Result Message 3700. When the proper Message Class Record 4302 is found, the GLOME knows which Libraries 4303,4304 to fetch from its Library Engine 202.

The GLOME 106 also checks the User Identifier 701 in the Result Message 3700 for a non-null and valid user identifier. If the User Identifier 701 is valid and non-null, the GLOME searches the IOS User Records 2204 in its message Mapping Table 203 based on the User Identifier 701. When the matching IOS User Record 2204 is found, the Message Class List 4102 is searched using the Message Class 3704 from the Result Message 3700. When the proper Message Class Record 4102 is found, the GLOME knows which Libraries 4103,4104 to fetch for its Library Engine 202.

If the GLOME cannot find a message in its Message Table, it queries the I-GVR 108 using the User Identifier 701 if the message is from or to a user and the O-GVR using the POD ID 401 if the message is to or from a POD.

FIG. 23 is a block diagram of an embodiment of the MSG POD Record 2300 contained in the Message Mapping Table 203. Its key is the POD Identifier 401 and it contains a list of MSG Records 906 keyed by Message Number 2401. It also contains a list of Device Library Records 2305 keyed by MSG Class 3704.

FIG. 24 is a block diagram of an embodiment of the Message Record 906 that is contained in the MSG POD Records 2300 and MSG User Records 2202. Each MSG Record 906 contains a sequential list of Library Ids 2402, 2403 corresponding to the Library Ids 1801,1901,2001, and 2002 of the libraries that need to be loaded into the GLOME 106 Library Engine 202 to process the parameters passed in a message with the message number 2401.

FIG. 25 is a block diagram of an embodiment of the Device Library Record. It is keyed by Message Class 3704 and contains links to the proper Device Libraries along with the Library ID in 2502.

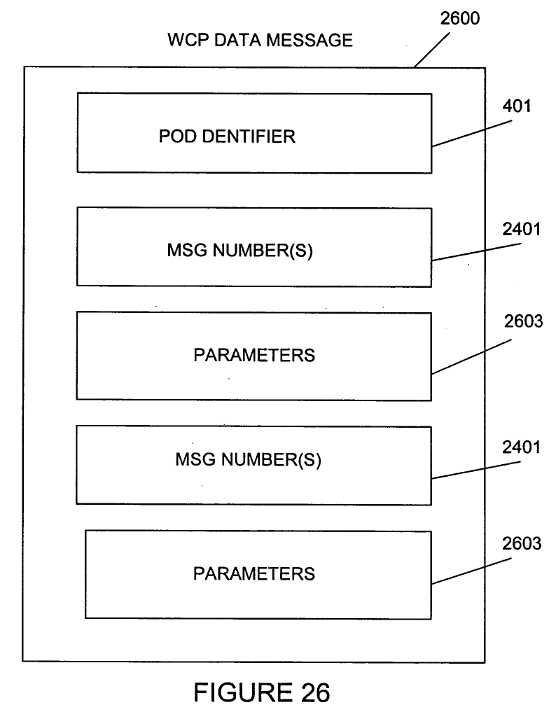

FIG. 26 is a block diagram of an embodiment of WCP Data Message 2600 that is sent from a POD to a GLOME. It is encapsulated in a WCP Message 4000 in the Payload 4004. The WCP Message Type 4002 is set to WCP DATA Message. The WCP Data Message 2600 contains one or more Message Numbers 2401 that correspond to Message Numbers in the MSG POD Record 2300 that matches the POD Identifier 401 in the Message Mapping Table 203 for the GLOME 106. Parameters that are needed by the Libraries loaded in the Library Engine 202 of the GLOME 106 for the specific message are included in the Parameters List 2603 for each Message Number 4201 as needed.

Since the same triggers rules with the same set of parameters in a POD could be set by different user or Lynx Libraries, there can be multiple MSG Numbers 2401 owning the same set of parameters.

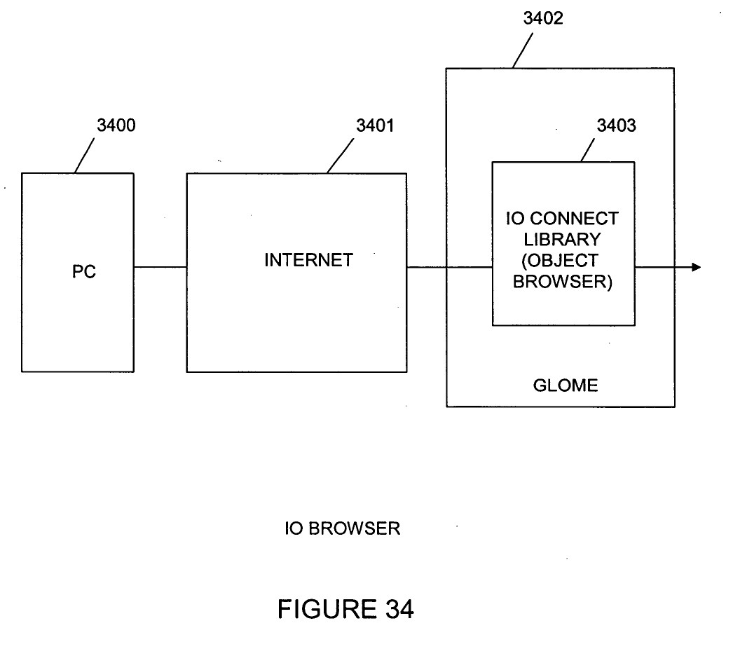

FIG. 34 is a block diagram of an embodiment of a user using an Object Browser from a standard Web Interface on their PC 3400. In this case the PC 3400 communicates over the Internet 3401 to a GLOME 3402. When the User logs onto the GLOME 3402, it loads the user's preferred Browser IoConnect Library 3403 in the library engine 202 based on the Browser IoConnect Library Link 707 in the I-GVR Record 602 for the users Identity 701. The Library Engine 202 then runs the browser, typically the Object Browser, for the user.

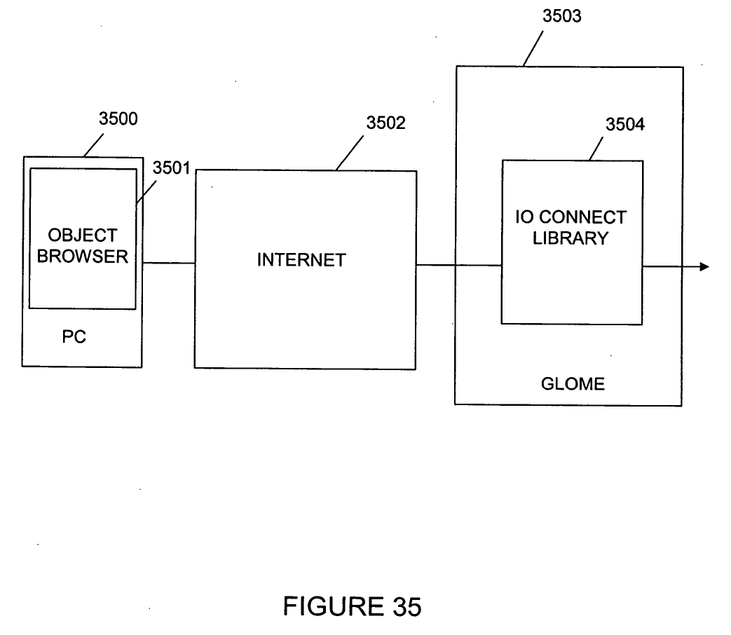

FIG. 35 is a block diagram of an embodiment of a user using Object Browser 3500 software on their PC 3501. The Object Browser 3500 communicates over the Internet 3502 to the GLOME 3503. When the Object Browser Software 3500 logs onto the GLOME 3503, it loads the remote Browser IoConnect Library 3503 into the library engine 202 based on the Browser IoConnect Library Link 707 in the I-GVR Record 602 for the users Identity 701. The Library Engine 202 then runs the browser, typically the Object Browser, for the user. The Browser IoConnect Library Link 707 in the I-GVR Record 602 is set specify a remote browser prior to this operation.

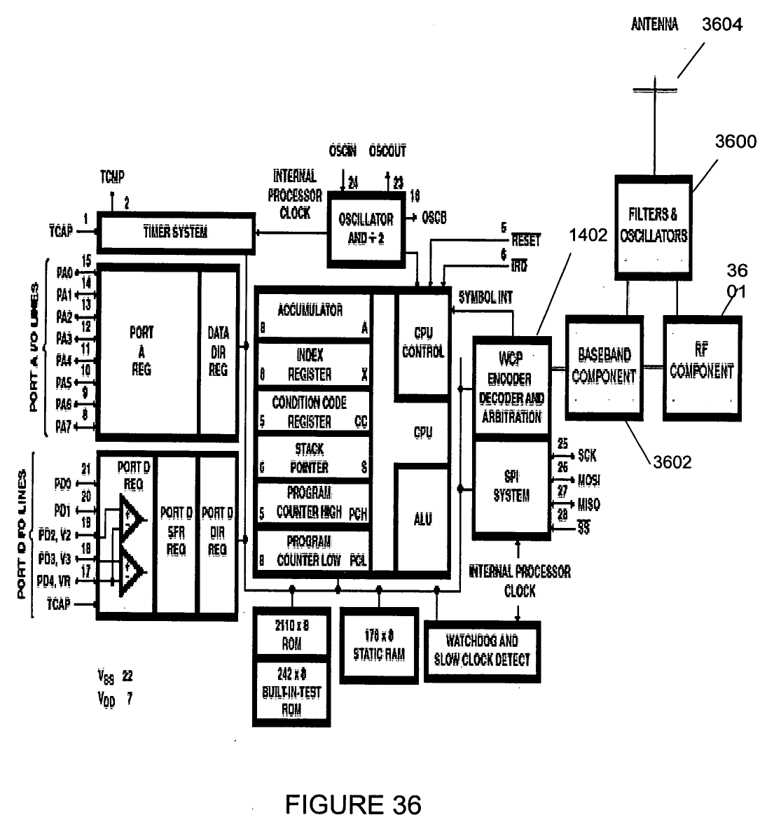

FIG. 36 is a block diagram of an embodiment of a MicroPOD that is designed to emulate an existing controller chips. In this example, the MicroPOD is a pin compatible replacement for a typical microcontroller with the addition of 3601, 3601, 3602, and 1402. The MicroPOD communicates to a GLOME 106 through an external wireless network 102 using the WCP Encoder Decoder and Arbitration Function 1402 and industry standard components imbedded or external to the MicroPOD. The industry standard components which are fabricated on the pin compatible component include the base band component 3602 which modulates the signal, the RF Component 3601 which converts the modulated signal to an RF signal, and the Filters and Oscillators 3600 which filter the RF signals and amplify them. The Antenna 3604 then attaches to the Filters and Oscillators 3600. In one embodiment of a wireless MicroPOD as shown in FIG. 36, the RF component 3601 contains an LNA, power amplifier and first RF stage in a single RF ASIC. Several external bandpass filters and oscillators are all that are additionally required. In one embodiment of a wireless MicroPOD as shown in FIG. 36, the BaseBand Component 3602 decodes and encodes the samples from the RF section and provides L2 and L3 encoding. The encapsulated data packets are passed on to the WCP Encoder Decoder and Arbitration Function 1402, where they are processed by the WCP kernel in the POD Software Object 404. MicroPODs that connect to GLOMEs 106 via wired access networks such as 103, 104 and 105 do not require the components 3600, 3601, 3602 and 3604. They instead connect to the wired network directly via the WCP Encoder Decoder and Arbitration function 1402. In one embodiment, all of the PODs, not just wireless MicroPODs, contain the WCP Encoder Decoder and Arbitration function 1402. The WCP Encoder Decoder and Arbitration function 1402 contains the functions and capabilities shown in FIG. 4. A further description of the Elements of a POD including the WCP Encoder Decoder and Arbitration function 1402 and POD functions from FIG. 4 is given below.

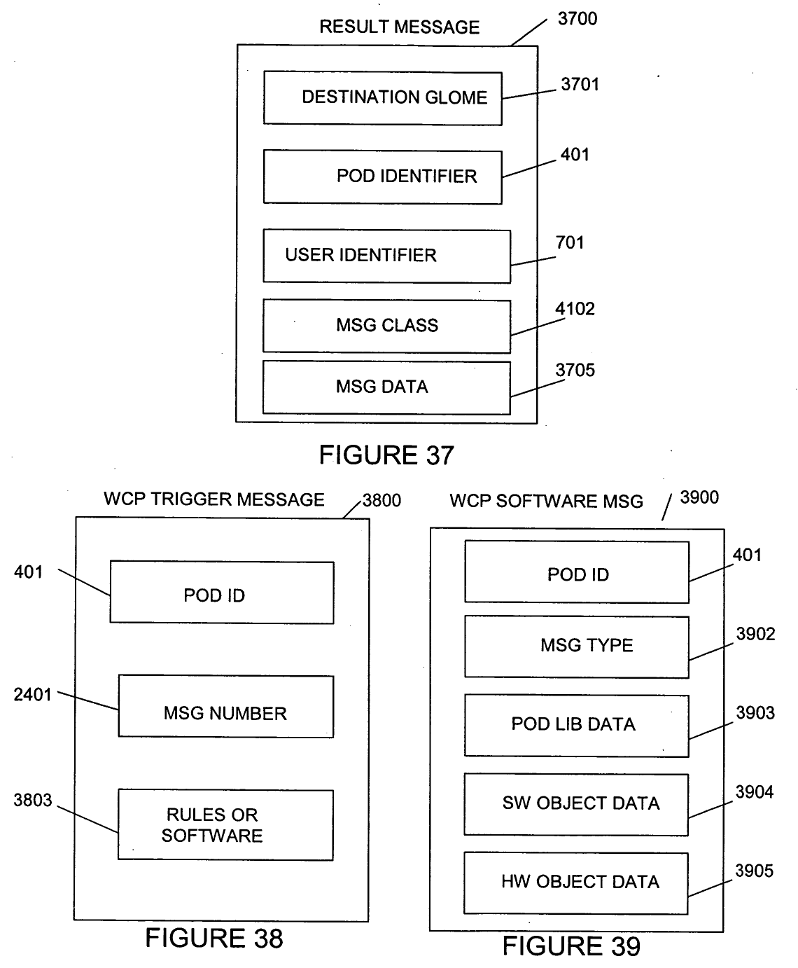

FIG. 37 is a block diagram of an embodiment of a Result Message 3700 that is sent between GLOMEs 106 over the internal IOS Bus 312. The Result message contains the address of the GLOME it is destined for 3701. It also contains a POD Identifier 401 if the message is destined for a POD or a User Identifier 701 if the message is destined for a user. The Message class of the message is contained in 3704 and all message data is contained in 3705. When the receiving GLOME gets the message, it will use the POD Identifier 3703 and/or the USER Identifier 3703 to look in its Message Mapping Table 203 and the MSG Class 3704 to fing the proper IOS User Record 2204 or IOS POD Record 2203.

FIG. 38 is a block diagram of an embodiment of a WCP Trigger Message 3800. The WCP Trigger Message is sent from a GLOME to a POD encapsulated in the Payload 4004 of a WCP Message 4000 with MSG TYPE 4002 set to WCP Trigger. The WCP Trigger MSG 3800 contains information on a new set of trigger rules, result parameters, and/or software 3803 that the POD must add to its trigger logic 2004 and/or execution logic 2006. The POD associates the MSG Number 2401 with the rules in its Message Table 2005. When the trigger rules are met, the POD generates a WCP Data Message 2600 to the GLOME containing the MSG Number 2401 and parameters 2603. The GLOME uses its Message Mapping Table 203 to decide which libraries to use, and the proper destination of the message.

FIG. 39 is a block diagram of an embodiment of a WCP Software Message 3900. The WCP Software Message is sent from a POD to a GLOME encapsulated in the Payload 4004 of a WCP Message 4000 with MSG TYPE 4002 set to WCP Software Message. The MSG Type 3902 defines where the data is being sent to and can be set to POD Library, Software Object, or Hardware Object. Information sent to the Software Object is used to Control or modify the PODs Software Object and is sent in the SW Object Data Field 3904. Information sent to the Hardware Object is used to Control the Hardware Registers of the device the POD is emulating and is sent in the HW Object Data Field 3905. Information for the POD Library is sent in the POD Library Data field 3903.

FIG. 40 is a block diagram of an embodiment of a WCP Message 4000. The WCP Message is used to send messages back and forth between PODs and GLOMEs. Its primary objective is for maximal security and its payload is encrypted using the POD Authentication Key 402. The message header 4001 is used to transport it properly over the access networks 102,103,104,105 and is access network dependent. The message type 4002 can be WCP Trigger Message, WCP Software Message, WCP Data Message, or Generic. The Encryption Info 4003 is used in conjunction with the POD Authentication Key 402 to provide maximal security. The POD Authentication Key 402 is never send in a WCP message, only a RAND in the Encryption Info field 4003. The Payload is encrypted using methods based on A3/A5/A8 encryption techniques.

FIG. 41 is a block diagram of an embodiment of an IOS USER Record 2204 that is contained in the GLOME 106 Message Mapping Table 203. It is keyed on the User Identity 701 and contains a list of Msg Classes 4102. Each Message Class 4102 in the list has a sequence of Library Ids 4103, 4104 that let the GLOME 106 know which libraries to load in its Library Engine 202.

FIG. 42 is a block diagram of an embodiment of a MSG USER Record 2202 that is contained in the GLOME 106 Message Mapping Table 203. It is keyed on the User Identity 701 and contains a list of Msg Records 906.

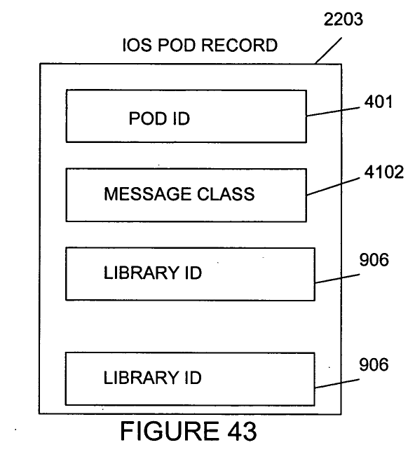

FIG. 43 is a block diagram of an embodiment of an IOS POD Record 2203 that is contained in the GLOME 106 Message Mapping Table 203. It is keyed on the POD Identifier 401 and contains a list of Msg Classes 4102. Each Message Class 4102 in the list has a sequence of Library Ids 4303,4104 that let the GLOME 106 know which libraries to load in its Library Engine 202.

Programmable Object Devices

Programmable Object Devices (PODs) are small control devices and come in four versions; a remote POD (rPOD) that has physical wire interfaces, a Virtual Software POD vPOD, a microcontroller replacement POD (MicroPOD) as shown in FIG. 36. The MicroPOD is a pin compatible replacement for standard microcontrollers/microprocessors. The fourth version is a more intelligent POD (IntelliPOD) that can accept JAVA applets and intelligent agents 406. These POD versions come in a variety of access options for connectivity to the Internet. These include wireline, wireless and combined wireline/wireless options. The PODs are based on object model principles, and use advanced integrated circuit techniques to be deployable like a typical low cost microcontroller, but can also connect to the Internet.

Wireless PODs can communicate wirelessly through the existing wireless access network 102 eliminating the need to purchase expensive private radio systems or deploy bulky cabling and wiring. Wireless PODs communicate to a GLOME 106 through an external wireless network 102 using the WCP Encoder Decoder and Arbitration Function 1402 and industry standard components imbedded in or external to the POD. The industry standard components which are fabricated on the pin compatible MicroPOD include the base band component 3602 which modulates the signal, the RF Component 3601 which converts the modulated signal to an RF signal, and the Filters and Oscillators 3600 which filter the RF signals and amplify them. The Antenna 3604 then attaches to the Filters and Oscillators 3600. PODs that connect to GLOMEs 106 via wired access networks such as 103, 104 and 105 do not require the components 3600,3601,3602 and 3604. They instead connect to the wired network directly via the the WCP Encoder Decoder and Arbitration function 1402. PODs typically contain the WCP Encoder Decoder and Arbitration function 1402. The WCP Encoder Decoder and Arbitration function 1402 contains the functions and capabilities shown in FIG. 4.

FIG. 14 provides is a block diagram illustrating one embodiment of a POD. However, it should be realized that PODs come in multiple types including Remote PODs (rPODs), MicroPODs, vPODs and IntelliPODs. RPODS have electrical interfaces that connect with existing Devices 313 while MicroPODs emulate off-the-shelf controllers and are described in FIG. 36. VPODs are software only entities that can be linked with existing software devices to create a Virtual POD. This is useful for Software entities that appear as devices to the IOS. IntelliPods are rPODs, vPODs or MicroPODs with additional JAVA Intelligence as described in FIG. 4. The POD 300 consists of an Access Network Interface 1403 that interfaces with an Access Network 1404. Typical Access Networks 102,103,104,105 are shown in FIG. 1. The POD also has a Device Interface 1401 that interfaces with the Device 313 it is imbedded within. This interface can be a set of electrical or TTL interfaces for an rPOD and is typically a pin compatible controller interface for a MicroPOD as described in FIG. 36. The POD 300 also contains a WCP Encoder Decoder and Arbitration Function 1402 which is described in FIG. 4. The WCP Encoder Decoder and Arbitration Function 1402 is software based and can be deployed as a software entity in a device. In this case, the POD is a Virtual POD (vPOD).

PODs can be connected to devices to control and monitor signals, or as direct replacements for the microcontrollers or microprocessors that are already designed for use in the object. MicroPODs, when replacing microcontrollers and microprocessors appear to be identical to the devices that they replace in both cost and functionality, but have an additional capability of communicating through an embedded WCP Encoder Decoder and Arbitration Function to a GLOME 106 at the edge of the IOS. An example of the WCP Encoder Decoder and Arbitration Function for a MicroPOD is shown in FIG. 36.

The Programmable Object Devices (PODs) can be used for applications ranging from home appliances to automotive diagnostics. Like a standard microcontroller, the POD has software definable parallel and serial ports and FLASH EPROM program store. Wireless versions of the POD can leverage off of the existing cellular network to send and receive short bursts of information using the Wireless Control Protocol (WCP) described in FIGS. 26, 38, 39 and 40. POD hardware port characteristics can be set using WCP Software Messages 3900 with the Hardware Port information contained in the Hardware Object Data Field 3905. These ports correspond to IO pins and ports in the MicroPOD, or to Proprietary interfaces like ODB-II in the rPODs.

Autonomously or when requested, PODs can transmit or receive short bursts of data from GLOMES 106 at the edge of the IOS 100. These short bursts of data are WCP Messages 4000. Since PODs need to communicate with GLOMES 106 over existing access networks and infrastructures 102, 103, 104, 105 there are several access options that a POD can be manufactured with. These include but are not limited to Basic Wireline/LAN, Basic Wireline/Modem, Basic Bluetooth, LAN/Ethernet, xDSL, Cable Modem, Modem, Residential Gateway, GSM, CDMA, TDMA, 802.11, WiMAX, HyperLAN 1 and 2, HomeRF, 3G, LMDS, MMDS, Broadband, GPS and Custom. PODS may also have additional Bluetooth and GPS capabilities included at manufacture time.

Object Browser

An Object Browser can consist of an IoConnect Library 2403 and standard HTTP browser PC 3400 as shown in FIG. 34 or as an IoConnect Library 3504 used in conjunction with Object Browser software 3501 on a user's PC 3500 as shown in FIG. 35. The Object Browser is the Portal for human users to access the IOS and for modifying and monitoring devices and other users. It is also used to define new rules and trigger conditions for PODs and users. These rules are stored in Lynx Libraries 1800, Message Records 2303 and published to individual PODs using WCP Trigger Messages 3800 via GLOMES 106. The Object Browser has many unique features. In one embodiment, the Object Browser supports graphical Icons representing the PODs and users in the IOS 100. These graphical icons are called IoIcon Libraries 1303 and are stored in IoIcon Library Repositories 117. The IoIcons are Intelligent Icons that graphically represent a simple or complex POD imbedded Device 313 and have pull-down menus with sub-object support. Sub-objects are objects and attributes contained within a Device. For example, an automobile could contain a stereo sub-object with a volume control parameter. In this example, an object that appear to be an automobile would appear in the object browser. A user could select an icon that look like a stereo on the dashboard of the car icon. Once the stereo icon is chosen the user could manipulate the stereo settings in order to manipulate the actual car stereo functions, or link one function in the stereo to another function within the IOS. By linking one function to another, a user can set up a rule wherein one event occurring in one device results in an action being taken on another device.

In one embodiment, the Object Browser supports web links and ObjectLinks. Weblinks link to web pages inside and outside of the IOS, while ObjectLinks link to POD imbedded Devices 313 in the IOS. The can be in a format like www.xxx.obj and are used to interact with objects in the network. Using weblinks and objectlinks, a user or intelligent POD can perform Object Searches, Phrase Searches, Attribute Searches and Directory Listing Searches. Connectivity searches can also be performed to graphically see how objects, users and sub-objects are interconnects and interrelated.

In one embodiment, the Object Browser allows the user or POD to search, modify and create new Shareware Libraries, Device Libraries, Connect Libraries, Lynx Libraries, and Private Libraries that are physically contained in the Library Repositories.

In one embodiment, the Object Browser allows the user to graphically display Libraries and generate linking rules and parameter mappings amongst them. In this case, the user will also be able to use a graphically based Internet/Object Icon (IoIcon) editor to make new intelligent Icons and rules templates when needed. Device Libraries will be pictorially displayed with a representation of Device to Message Class mapping and rules. The IoConnect Libraries will be pictorially displayed with a representation of existing protocols such as Wireless Application Protocol (WAP), and ASP to IOS mapping and rules. The user can use an easy Internet/Object Icon (IoIcon) editor to make new intelligent Icons and to generate WAP/ASP/etc. to standard object mappings and rules.

The Lynx Libraries will be pictorially displayed with a representation of interaction between devices and the capability to use Drag and Drop methods to connect and specify rules amongst POD imbedded Device and user. The Object Browser also provides graphical representation of Message Class 4102 to Message Class 4102 mapping for connecting and providing cascaded rules amongst Lynx Libraries 1800, Device Libraries 1900 and IoConnect Libraries 2100. The Object Browser also provides graphical representation of mapping to external protocols such as XML for external application programs and WAP protocol to wireless phone users. The Triggering rules and controllable parameters in Devices including event, alarm and trigger access points will be graphically represented along with picture quality graphical representations of the physical controls, displays and functions of the Device the POD is embedded in. The user will also be able to build relationships between devices, users and libraries using drag and drop capabilities coupled with the IoIcons. Some PODs may communicate directly amongst themselves using Bluetooth or WIFI without going through a GLOME 106 or the IOS. In this case the rule are graphically defined in the Object Browser.

In one embodiment, the Object Browser allows the user to chat with other users in closed communities. In one embodiment, the Object Browser allows the user to navigate through a virtual village of devices and user Icons (pictures) under their control and modify and interconnect the objects. In one embodiment, the Object Browser allows the user to navigate through a virtual village of devices and user Icons (pictures) that have been made visible to them by other users. In one embodiment, the Object Browser allows the user to navigate through a virtual village of devices and users Icons (pictures) that have been made visible and partially or fully modifiable by them by other users.

In one embodiment, the Object Browser allows the user to define which of their devices are viewable in various virtual communities, and which parameters are visible and modifiable by others in each community. In one embodiment, the Object Browser allows the user to enable or disable functionality of a device. For example, this capability could be used to remotely block Television stations from being viewable or disabling a car remotely. This can also be used by device manufacturer to upgrade device capabilities remotely when a device owner orders upgraded device functionality.

In one embodiment, the Object Browser allows the user to enable or disable functionality of a device. For example, this capability could be used to remotely block Television stations from being viewable or disabling a car remotely. This can also be used by device manufacturer to upgrade device capabilities remotely when a Device owner orders upgraded device functionality.

In one embodiment, the Object Browser allows a software vendor to remotely control a Software Object instead of a POD. This is used if the Device being controlled is licensed software and allows owners of software download sites to control licensing of products. In one embodiment, the Object Browser allows the user to create and/or join virtual communities of users and virtual cities composed of their devices and other devices and control other visible devices. In one embodiment, the Object Browser allows the user to create and/or join virtual communities of users and virtual cities composed of their devices and other devices and chat and exchange data with other users.

In one embodiment, the Object Browser allows the user to create and/or modify IoIcons representing their user mail and office systems interfaced via a GLOME and define the rules between these systems and their own Devices and users. In one embodiment, the Object Browser allows the user to create, set, monitor and/or modify Alarms in devices using Graphical Colored icons and graphically based rules/connection screens. In one embodiment, the Object Browser allows the user to create, set, monitor and/or modify Events in devices using Graphical Colored icons and graphically based rules pages to define event processing. In one embodiment, the Object Browser allows the user to create, set, monitor and/or modify Triggers in devices using Graphical Colored icons and graphically based representations of triggers to cause user or object rules to be executed. In one embodiment, the Object Browser allows the user to create, set, monitor and/or modify Parameter Controls in devices using Graphical Colored icons and graphically based IoIcon that look like the device with pull down menus.

In one embodiment, the Object Browser allows the user to upload download, and/or modify software in the Devices using a Drag and Drop Software download function. In one embodiment, the Object Browser allows the user to upgrade software in the Devices using a Drag and Drop Software upgrade function. This will typically be done by the Device Manufacturer user type to upgrade a Buyers device with more functionality after the device is bought. This will also be done by the POD manufacturer to update PODs in the field, and Device Manufacturers to install software during and after manufacturing.

User Account

During a PODs lifecycle, multiple Individual and business accounts will interact with the POD. These will typically include the POD Manufacturer, the Device Manufacturer, one or more Device Sellers and one or more Device Buyers. Each of these users will preferably have a user account. The user accounts are created in the Internet Global Virtual Registry (I-GVR) 108 and are placed in one of the I-GVR Records 602 using the provisioning system 113. The users will then be able to build libraries and interact with their PODs, other users PODs that are visible, and other users using an Object Browser portal that is connected through an IoConnect Library 2100 hosted in a GLOME's Library Socket 201.

When a new user including an Individual, External Application Software or Automaton signs up to use the IOS 100, the provisioning system 113 is used to create a new I-GVR Record 602 at the I-GVR 600. As illustrated in FIG. 7, the I-GVR record 602 contains the User Identity 701 and User Password 702. The User State Block 703 is set to active and subscribed if the user has paid their bill and is active in the IOS. The type of user is entered in the User Type Field 704. This field differentiates between POD Manufacturer, Device Manufacturer, Inventory, Seller, Buyer or Customer. If a new user has devices with PODs imbedded in them, an O-GVR List record 705 is added to the I-GVR record 602 for each device. The O-GVR List record 705 contains the POD Identifier 401 that is the same as the POD Identifier in the O-GVR Record 502 and the POD 300. User information is entered in the User Information field 706. The Device Record 802 is automatically retrieved from the O-GVR 107 using the POD Identifier 401 and stored in the O-GVR list record 705. The IoIcon link 1206 from the Device Record is also stored in the IoIcon Link 803. Users can subscribe to the state of objects using the IoWatch Subscription function 804. If a user wants to collect statistics on a POD enabled device, this desire is stored in the IoStats field 805. External application program accounts are also provisioned in the provisioning system 113 to create a new I-GVR Record 602 at the I-GVR 600.

POD Registration

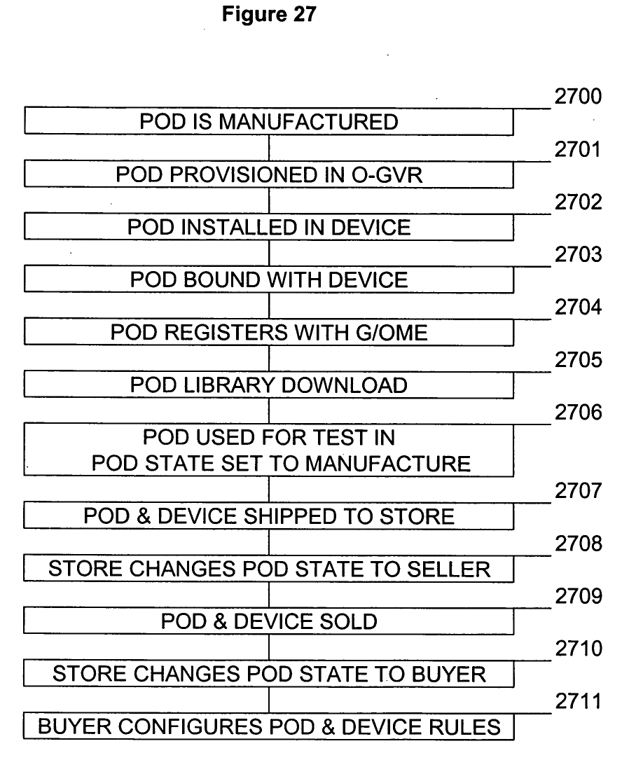

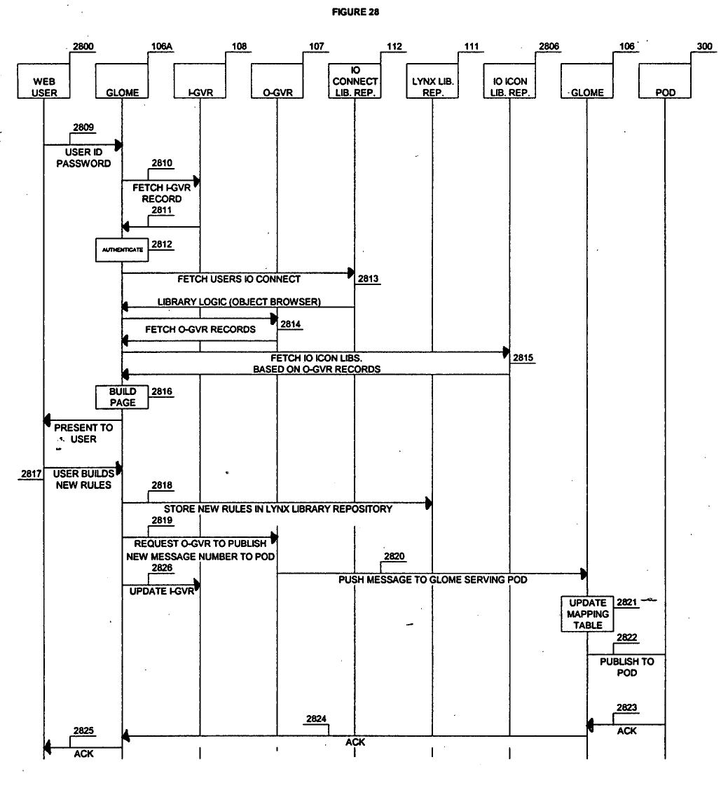

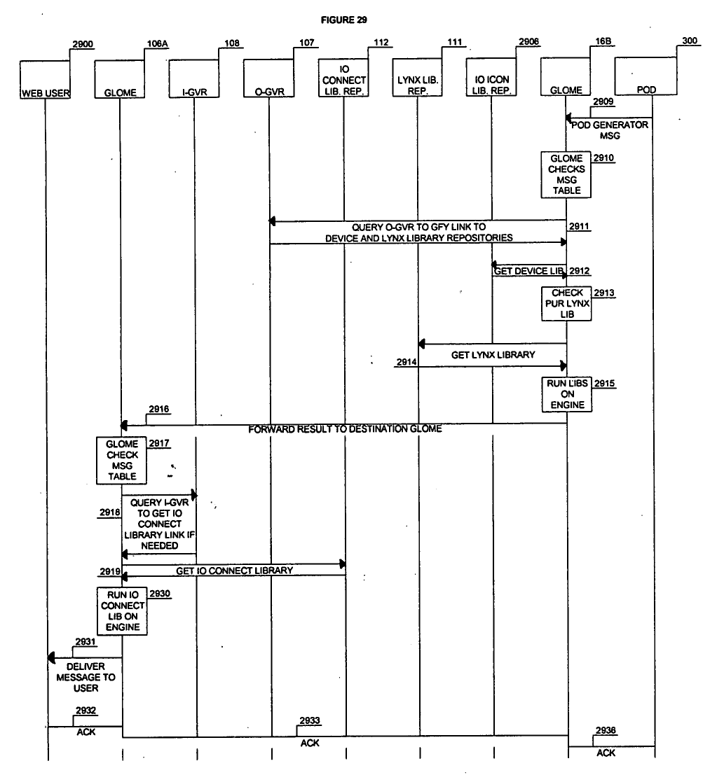

FIG. 27 is flow diagram illustrating one embodiment of a method of enabling a POD for control, interaction and monitoring in the IOS 100. After the POD is manufactured in a step 2700, its unique POD Identifier 401 and POD Authentication Key 402 are provisioned in a step 2701 in the O-GVR 107 using the provisioning system 113. The provisioning system 113 creates an O-GVR Record 502 in the O-GVR 500 that is keyed by the POD Identifier 401. The POD Record 902 is created within the O-GVR record 502 containing the Authentication Key 402 and POD information 1002 such as the POD Manufacturer, POD Hardware Version, and POD Software. The POD State block 1003 is set to inactive. The Current POD Library link Block 1004 is left empty. The Device Record 802 is left empty as well as the Attachment GLOME address 407. The I-GVR List Record 905 contains a link to the POD manufacturer's I-GVR record 1104.

During or after manufacture of a device, a POD is installed in the device in a step 2702. For the POD enabled device, a device manufacturer can use an IOS Portal to bind the POD 300 to the Device in a step 2703. This procedure modifies the existing O-GVR record 502 for the POD by updating the POD Record 902 to include a Current POD Library Link 1004 that specifies the proper POD library for the device in which the POD 300 is installed. The POD State Block 1003 is also set to Active with an Owner State of “Manufacturer”. Device information for the POD enabled device is stored in the Device Record 802, and may include the Identity of the Device 1201 which is typically a name, and the Serial Number and Version of the Device in the Device Information field 1203. The Device Class 1202 is also entered in the Device Record 802 to help identify the proper libraries to use with the device. The Device State Block 1204 is set to Manufacturer.

If the device is a piece of hardware, the Device State Block 1204 is set to Hardware. Software and digital Media such as Music, videos, etc can also be tracked with the IOS. In the case of a software device, the Device State Block indicates Software instead of Hardware. Also, there is no POD associated with the Software/Digital Media, only a serial number. The POD Identifier 901 therefore is used only as a key in the O-GVR and does not refer to an actual piece of hardware. A link to the Proper Device Library is entered in the Current Device Library Field 1205 and a link to the IoIcon Library is entered in the IoIcon Link 803. The Device Manufacturer also adds their I-GVR link 1101 to the I-GVR List Record 905.

When the POD enabled device is turned on or powered up, the POD registers with the GLOME 106 identified in the GLOME Attachment Address 407 via an access network 102, 103, 104, 105 in a step 2704. The POD 300 transmits the POD Identifier 401, and the POD Authentication Key 402. The Local Virtual Registry module 205 and AGCP module 206 at the GLOME 106 are used to query the O-GVR 107 using the POD Identifier 401. In response to the query, the O-GVR 107 returns the O-GVR record 502 for the POD 300. The GLOME 106 may use a standard RAND authentication algorithm to authenticate the POD Authentication Key from the POD record 902 against the Authentication Key from the POD 300 using the Authentication Function 209 at the GLOME 106 and the Authentication Function 408 at the POD 300.

Once the POD is authenticated, the O-GVR 107 stores the attachment GLOME's IP address 407 in the O-GVR record 502 and changes the POD State Block 1003 to Active—Manufacturer. The GLOME 106 also retrieves the POD Library 303 defined in the current POD Library 1004 from the POD Library Repository 109, and downloads the library to the POD Library Socket 403 in the POD 300. The device manufacturer may want to use the POD to test the device 300 in a step 2706. The device manufacturer may use their Portal to download testing software to the POD 300, and the testing software is loaded in the POD Software Object 404, and the Device State Block 1204 at the device record 802 is set to testing.

Following device testing in step 2706, the device is shipped to the device seller's warehouse for sale in a step 2707. The Device Seller changes the Device State Block 1204 in the device record 802 using their portal in a step 2708. A link to the sellers I-GVR record will be included in the I-GVR Seller Link field 1102. Additional information on the Seller can be included in the Additional Information Field 1105 of the I-GVR List Record 905. When the seller sells the device to a buyer 2709, the seller changes the Device State Block 1204 in the device record 802 to Buyer and adds the Buyer's I-GVR Link 1103 to the I-GVR List Record 905 if the Buyer has an IOS account. The Buyer can now log into their portal and interact with the device 300 via the imbedded POD. The Device Manufacturer can also interact with the device via their portal to collect statistics and upgrade software.

Using the Object Browser to Set up Dynamic Interaction Relationships

Once the users in the IOS 100 have accounts (I-GVR Records), the IOS 100 enables them to interact with each other and devices using a set of rules. A set of rules is specified for each interaction between Individuals, External application programs, and devices in the IOS. These rules are stored in libraries. These libraries include POD Libraries 2000 which are downloaded from the POD Library Repository 109 and installed at PODs 300 to mediate between devices and PODs; Device Libraries 1900 which are dynamically downloaded to GLOMEs 106 from the Device Library Repository 110 and used to mediate between devices and Lynx Libraries; Lynx Libraries 1800 which are dynamically downloaded to GLOMEs 106 from the Lynx Library Repository 111 to mediate between devices, users, or other Lynx Libraries; and IoConnect Libraries 2100 which are dynamically downloaded to GLOMEs 106 from the IoConnect Library Repository 112 and used to mediate between Lynx Libraries and individual users or external application programs. The POD Libraries are typically defined by the POD or device manufacturer, the Device Libraries are typically defined by the device manufacturer, the IoConnect Libraries are typically defined by the IOS service provider, and the Lynx Libraries are typically defined by the individual user.

When two or more users in the IOS 100 interact, they do so through the GLOMEs 106 to which they are attached. These GLOMEs dynamically download the proper libraries associated with the users according to their I-GVR Record 602 to allow the interaction when a user generates a message. FIG. 28 is a data flow diagram illustrating a method of communication between an Individual User 2800 and a POD 300 using an Internet portal. First the user 2800 logs into a GLOME 106 via a portal and transmits their User Name and Password (or other identification information) in a step 2809. The GLOME 106, knowing that the message is coming from an Individual User instead of a POD by virtue of the portal, queries the I-GVR 108 associated with the user's User Name and retrieves their I-GVR Record 602. The user 2800 is authenticated in a step 2812 by the GLOME 106 against the User Password 202 in the I-GVR record using the Authentication Function module 209 (see FIG. 2). The GLOME 106 checks the User State Block 703 to ensure that the user state is active and that the user 2800 has paid for service.

Based on the User Type 704 and Browser IoConnect Library Link 707, stored in the I-GVR record 602, the GLOME 106 checks the Library Cache 204 for the proper IoConnect Library for the User Type. If the library designated in the library link 70 is not in the library cache 204, the GLOME 106 retrieves the Browser IoConnect library from the IoConnect Library Repository 112 in a step 2813.

For each O-GVR List Record 705 in the I-GVR Record 700, the GLOME 106 retrieves the POD's O-GVR record 502 from the O-GVR 107 using the POD Identifier 401 in a step 2814. This ensures that the most current states of all PODs are provided to the user 2800. The GLOME 106 also fetches the IoIcon Libraries specified in the IoIcon Link 803 of each O-GVR List Record 705 from the IoIcon Library Repository 117 in a step 2815. The GLOME 2801 also fetches the Lynx Libraries specified in the Lynx Library List 708 from the Lynx Library Repository 111. The Lynx Libraries can be public or uniquely built and owned by the user 2800. If the user 2800 has subscribed to statistics database 118 or watcher status 119, the links to the repositories for this information are retrieved from the fields 804 and 805.

Once the libraries are fetched, the IoIconnect (browser) and IoIcon library logic is moved to the GLOME's Library Engine 202 for generation of a graphic user interface (GUI), such as a web page, that presents an Object Browser to the user 2800 in a step 2816. The Object Browser displays the status of all the PODs, devices, and users associated with the Individual User's Account using predetermined icons, such as graphical 3D Icons retrieved from the IoIcon Library. In one embodiment, substantially all parameters that can be monitored or controlled in each POD enabled device are displayed as a sub-icon of the device icon as it physically appears in the device and can be selected (clicked on) to modify or drop and dragged to couple with other physical devices (or controls).

For example a DVD player is displayed graphically as a virtual 3D DVD player with knobs, buttons, and displays, and an automobile will appear as a 3D automobile that can be rotated to view the dash or with its hood opened. If the user 2800 wants to make a new set of rules relating between the DVD player and the automobile, they can do so by dragging and dropping the relevant components from one device to another (or the same device) and establishing rules in a step 2817. For example, the user 2800 may want the DVD player to start playing a movie when the car is started. To implement this rule, the user 2800 drags a sub-icon representing starting the car, such as a key sub-icon in the car icon, over the power button sub-icon on the DVD player icon. In response to the overlay of the car start sub-icon over the DVD player power button sub-con, the Object Browser displays a rule screen, wherein the user 2800 can specify that the power is to be turned on when the key is turned on by selection of predefined parameters, for example. Then the user 2800 drags the DVD power button sub-icon over the DVD play button sub-icon, and selects a rule corresponding to the instruction that the DVD player start playing when its power is turned on.

Once the user 2800 has defined one or more rules for their associated devices, the IoConnect Library, which is acting as the Object Browser, generates a new Lynx Library with the new rules, and this new Lynx Library is stored in the Lynx Library Repository 111 with a unique name in a step 2818. The new Lynx Library is also added to the Lynx Library list 708 in the user's I-GVR Record 602 at the I-GVR 108 in a step 2826. For each POD enabled device affected by the new rules, the IoConnect Library acting as an Object Browser, generates a set of trigger rules and a message number based on the new rules in the new Lynx Library. In one embodiment, the message number for each individual POD is one greater than the highest message number 2401 already stored in the MSG Record 2400 for that POD. Existing trigger rules that are changed or removed, will be flagged to be removed in the Message Record 906 in the O-GVR Record 502 and will be published to the GLOME 106 servicing the respective POD.

The GLOME 106A stores the new Message Record 906 at its O-GVR Record 502. The GLOME 106A then uses the Application Gateway Control Protocol (AGCP) Interface 206 to send an update to the O-GVR 107 with the POD identifier 401, updated O-GVR Record 502, and an encapsulated WCP Trigger Message 3800 (FIG. 38) in a step 2819. The O-GVR 107 Message Records 906 field is updated in its O-GVR Record 502 for the POD 300 according to the updated O-GVR Record 502 from the GLOME 106A. The O-GVR 107 forwards the O-GVR Record 502 to the GLOME 106B to update its Message Mapping Table 203 using AGCP and forwards the WCP Trigger Message 3800 to the GLOME 106B for GLOME 106 B to forward to the Proper POD using a Result Message 3700. This is done to tell the POD to make a new set of trigger rules in its Trigger Logic 2004 and MSG Table 2005 as described in FIG. 20.

The O-GVR 107 knows which GLOME 106B to forward the message to based on the GLOME attachment address 402 at the O-GVR record 502 for the POD 300 in a step 2820. The messaging from the O-GVR 107 to GLOME 106B for the Encapsulated WCP Trigger Message 3800 is performed using a Result Message 3700 with a MSG Class 3704 set to “WCP Trigger Message” (FIG. 37). The POD Identifier 401 of the POD 300 associated with the device is sent in the POD Identifier Field 3702 of the Result Message 3700. When the GLOME 106B receives the Result Message 3700, it searches its Message Mapping Table 203 for a POD Record 2201 (FIG. 22) that matches the POD identifier 401, and forwards the trigger rules 3803 to the POD 300 according to the POD Record 2201 using the WCP Trigger Message 3800 in a step 2822. The POD 300 then updates its internal trigger rules and associates the new message number to the triggers as described in FIG. 20. The POD 300 then transmits an acknowledgement message to the GLOME 106B in a step 2823, which will be communicated to the GLOME 106A in a step 2824, and provided to the end user 2800 in a step 2825.

The GLOME 106B can update its Message Mapping Table 203 in a step 2821 upon receipt of the Result Message 3700, or wait until a new trigger is generated by the POD 300 when its sends a WCP Data Message 2600 to its associated GLOME 106B, which will check its MSG Mapping Table 203 for the new message number from the POD 300. If the number is not in the Mapping Table 203, the GLOME 106B queries the O-GVR 107 based on the POD Identifier 401.

POD to User Interaction

FIG. 29 is a data flow diagram illustrating one embodiment of a method of communication between a POD 300 and a user 2900. Following download of a POD trigger rule via a WCP Trigger Message 3800 as described above, the POD 300 waits until the trigger event occurs at the device. When the trigger event occurs as detected by the POD 300, the POD 300 sends a WCP Message 4000, with its MSG Type field 4002 set to “WCP Data Message Type”, to the GLOME 106B specified in the POD's GLOME Attachment Address Field 407 in a step 2909. The WCP Message 4000 comprises the WCP Data Message 2600 in its Payload 4004. The WCP message 4000 is preferably encrypted using the POD Authentication Key 402. Additional Encryption information, including an unencrypted copy of the POD Identifier, a temporary POD Identifier, or a RAND Key may be sent in the Encryption Information field 4003 in an unencrypted format. The WCP Data Message 2600 comprises the POD Identifier 401 of the POD 300 in the POD Identifier field 401. The message number assigned to the specific trigger event is placed in the Message Number Field 2401. If more than one interaction is mapped to the specific trigger, additional Message Number Fields 2401 are included for each interaction. Each Message Number Field 2401 includes a set of parameters 2603, associated with it that were defined by the POD Trigger rule.

Upon receipt of the WCP Message 4000 at the GLOME 106B, the unencrypted POD Identifier 401 (or Temporary POD Identifier) in the Encryption Information Field 4003 is used to look up the MSG POD Record 2300 in the Message Mapping Table 203 using the POD Identifier 401 in a step 2910. If the message had come from an Individual user or external application Program, the GLOME 106B would search the MSG User Records 2202 in the message mapping table 203. If the POD 300 has a record 2300 in the Message Mapping Table 203, the WCP Message 4000 is de-encrypted using the Authentication Function 209 and the Authentication Key 402 for the POD 300 that is stored in the Local Virtual Registry Function 205 of the GLOME 106B. The GLOME 106B then searches the MSG POD Record 2300 for the Message Record 2303 using the Message Number 2401 specified in the Message Number Field of the WCP data message 2600.

The Message Record 2303 identifies one or more Libraries IDs 2402, 2403 which correspond to the Libraries needed to process the WCP data message 2600. In one embodiment, the order of the Library IDs 2402, 2403 in the message record 2303 specifies the order that the libraries are placed in the GLOME Library Sockets 201 for use by the library engine 202. The libraries may be device libraries or lynx libraries, for example. In this example, the Destination User ID 2405 designates the end user 2900 for receipt of information in response to the trigger event. If the destination is a POD instead of a user, the Destination POD ID 2404 contains a POD Identifier 401 for the Destination POD. The Destination POD ID 2404 may be blank when the destination is an Individual user and not a POD. The GLOME 106B checks its Library Cache 204 to see if the device libraries specified by the Library Ids 2402 are there. If not, the GLOME 106B retrieves the library specified by the Library IDs 2402 using the Application Query Language function 207 in a step 2912. In one embodiment, Application Query Language is the same as SQL except it is optimized for retrieving execution logic (libraries). The GLOME 106B also checks if the Lynx Library identified by Library ID 2403 is stored in the GLOME 106B Library Cache 204 in a step 2913 and retrieves the Lynx Library from the Lynx Library repository 111 in a step 2914 if not in the cache 204. Since all Library IDs are unique, the Library IDs 2403 specify the Library Required.

Once the GLOME 106B has retrieved all of the libraries, the Library Engine 202 executes the libraries using the parameters 2603 passed in the WCP Data Message 2600 in a step 2915 and communicates the result in a result message 3700 to one or more destination GLOMEs 106A, as specified in the Destination User ID field 2405 of the MSG Record 2400, in a step 2916. The Result Message 3700 will contain the Destination GLOME Identifier 3701 and the Individual User Identifier 701 of the Destination User. The Message Class Field 3704 contains the Output Class 1803 specified by the last Lynx Library 2403 in the MSG Record 2303.

The GLOME 106B removes the libraries from the Library Engine 202 following execution, but continues to store the libraries and the authentication key 402 in its Library Cache 204 for later use until a specified time or until the library is explicitly removed. Since the Result Message 3700 is destined for an Individual User from the IOS, the Destination GLOME 106A checks the IOS User Record 2204 in its Message Mapping Table 203 in a step 2917 for the User Identifier 701 specified in the Result Message 3700. When the IOS User Record 2204 is found, the GLOME 106A searches for the record with the MSG Class 4102 as described in FIG. 41. This record will contains one or more Library ID's 4103, 4104 (FIG. 41) designating the IoConnection or Lynx libraries for execution at the Destination GLOME's 106A Library Engine 202. The GLOME 106A may need to fetch the libraries from the Io Connect Library Repository 112 in a step 2919. The GLOME 106A may also determine whether additional data is required from other triggering devices or users that it must wait for prior to executing libraries designated in the IOS User Record 2204 based on the logic in the Libraries 4103, 4104.

Once all of the triggers have occurred and the libraries are retrieved (if not cached) in step 2919, the libraries are executed on the Library Engine 202 at the GLOME 106A in a step 2930. The message generated in response to the execution of the libraries is communicated to the user 2900 in a step 2931 using the destination User Identifier 701 specified in the Result Message 3700, and the receipt of the message is acknowledged to the GLOME 106A in a step 2932. The acknowledgment is communicated to the GLOME 106B in a step 2933, and to the POD 300 in a step 2936.

If a GLOME does not have a record in the Message Mapping Table 203, the GLOME 2908 uses the POD Identifier 401 contained in the Encryption Info Field 2703 to Query 2911 the O-GVR 2903 associated with the POD. The O-GVR will download the O-GVR record 900 for the POD to the GLOME where it will be placed in the Local Virtual Registry Function 205 of the GLOME. This query and response can be performed using the Application Gateway Control Protocol 206 function in the GLOME 106B. The GLOME 106B will then store the Message Records 906 for the POD 300 in the Message Mapping Table 203 as a Message Record 2400 and the Authentication Key 402 in the GLOME's Local Virtual Registry 205.

POD to POD Interaction

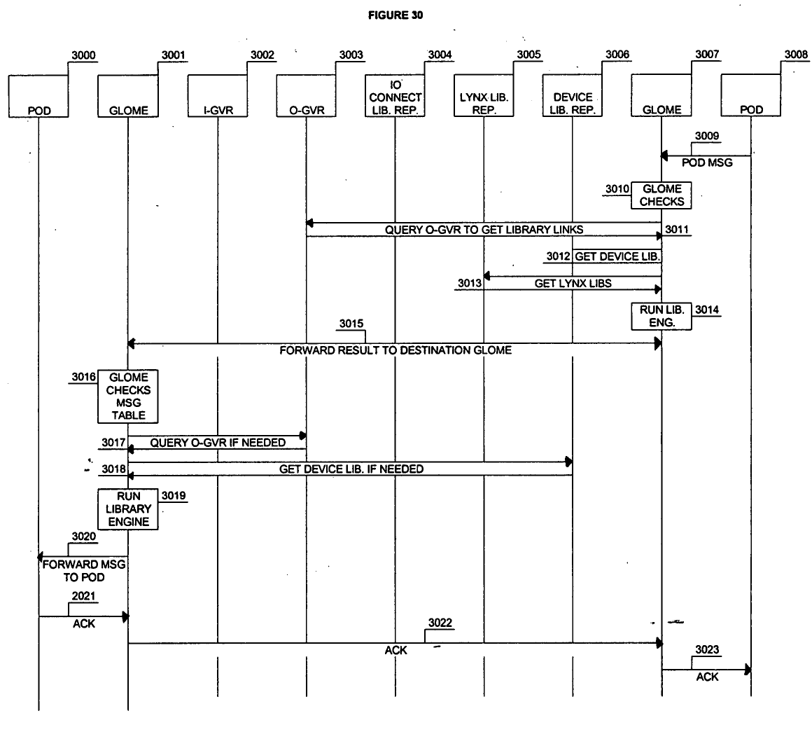

FIG. 30 is a data flow diagram illustrating one embodiment of a method of communication between one POD 3008 and another POD 3000. Following download of a POD trigger rule via a WCP Trigger Message 3800 as described above, a POD 3008 waits until the trigger event occurs at the device. When the trigger event occurs as detected by the POD 3008, the POD 3008 sends a WCP Message 4000, with its MSG Type field 4002 set to “WCP Data Message Type”, to the GLOME 3007 specified in the POD's GLOME Attachment Address Field 407 in a step 3009. The WCP Message 4000 comprises the WCP Data Message 2600 in its Payload 4004. The WCP message 4000 is preferably encrypted using the POD Authentication Key 402. Additional Encryption information, including an unencrypted copy of the POD Identifier, a temporary POD Identifier, or a RAND Key may be sent in the Encryption Information field 4003 in an unencrypted format. The WCP Data Message 2600 comprises the POD Identifier 401 of the POD 3008 in the POD Identifier field 401. The message number assigned to the specific trigger event is placed in the Message Number Field 2401. If more than one interaction is mapped to the specific trigger, additional Message Number Fields 2401 are included for each interaction. Each Message Number Field 2401 includes a set of parameters 2603, associated with it that was defined by the POD Trigger rule.

Upon receipt of the WCP Message 4000 at the GLOME 3007, the unencrypted POD Identifier 401 (or Temporary POD Identifier) in the Encryption Information Field 4003 is used to look up the MSG POD Record 2300 in the Message Mapping Table 203 using the POD Identifier 401 in a step 3010. If the message had come from an Individual User or External application Program, the GLOME 3007 would search the MSG User Records 2202 in the message mapping table 203. If the POD 3008 has a record 2300 in the Message Mapping Table 203, the WCP Message 4000 is de-encrypted using the Authentication Function 209 and the Authentication Key 402 for the POD 3008 that is stored in the Local Virtual Registry Function 205 of the GLOME 3007. The GLOME 3007 then searches the MSG POD Record 2300 for the Message Record 2303 using the Message Number 2401 specified in the Message Number Field of the WCP data message 2600.

The Message Record 2303 identifies one or more Libraries IDs 2402, 2403 which correspond to the Libraries needed to process the WCP data message 2600. In one embodiment, the order of the Library IDs 2402, 2403 in the message record 2303 specifies the order that the libraries are placed in the GLOME Library Sockets 201 for use by the library engine 202. The libraries may be device libraries or lynx libraries, for example. In this example, the Destination User ID 2405 is empty anf the Destination POD ID 2404 designates the POD 3000 for receipt of information in response to the trigger event. The GLOME 3007 checks its Library Cache 204 to see if the Device libraries specified by the Library Ids 2402 are there. If not, the GLOME 3007 retrieves the library specified by the Library IDs 2402 using the Application Query Language function 207 in a step 3012. In one embodiment, Application Query Language is the same as SQL except it is optimized for retrieving execution logic (libraries). The GLOME 3007 also checks if the Lynx Library identified by Library ID 2403 is stored in the GLOME 3007 Library Cache 204 in a step 3013 and retrieves the Lynx Library from the Lynx Library repository 111 in a step 3014 if not in the cache 204. Since all Library IDs are unique, the Library IDs 2403 specify the Library Required.

Once the GLOME 3007 has retrieved all of the libraries, the Library Engine 202 executes the libraries using the parameters 2603 passed in the WCP Data Message 2600 in a step 3015 and communicates the result in a result message 3700 to one or more destination GLOMEs 3001, as specified in the Destination POD ID field 2404 of the MSG Record 2400. The Result Message 3700 will contain the Destination GLOME Identifier 3701 and the Individual POD Identifier 401 of the Destination POD. The Message Class Field 3704 contains the Output Class 1803 specified by the last Lynx Library 2403 in the MSG Record 2303.

The GLOME 3007 removes the libraries from the Library Engine 202 following execution, but continues to store the libraries and the authentication key 402 in its Library Cache 204 for later use until a specified time or until the library is explicitly removed. Since the Result Message 3700 is destined for a POD from the IOS, the Destination GLOME 3001 checks the IOS POD Record 2203 in its Message Mapping Table 203 in a step 3016 for the POD Identifier 401 specified in the Result Message 3700. When the IOS POD Record 2203 is found, the GLOME 3001 searches for the record with the MSG Class 4102 as described in FIG. 43. This record will contains one or more Library ID's 906, 906 (FIG. 41) designating the Device or Lynx libraries for execution at the Destination GLOME's 3001 Library Engine 202. The GLOME 3001 may need to fetch the Libraries from the Device Library Repository 112, 3006 in a step 3018. The GLOME 3001 may also determine whether additional data is required from other triggering devices or users that it must wait for prior to executing libraries designated in the IOS User Record 2204 based on the logic in the Libraries listed 906.

Once all of the triggers have occurred and the Libraries are retrieved (if not cached) in step 3018, the libraries are executed on the Library Engine 202 at the GLOME 3001 in a step 3019. The message generated in response to the execution of the libraries is communicated to the POD 3000 in a step 3020 using the destination POD Identifier 401 specified in the Result Message 3700, and the receipt of the message is acknowledged to the GLOME 3001 in a step 3021. The acknowledgment is communicated to the GLOME 3007 in a step 3022, and to the POD 3008 in a step 3023.

If a GLOME does not have a record in the Message Mapping Table 203, the GLOME 3007 uses the POD Identifier 401 contained in the Encryption Info Field 2703 to Query 3011 the O-GVR 3003 associated with the POD 3008. The O-GVR will download the O-GVR record 900 for the POD to the GLOME 3007 where it will be placed in the Local Virtual Registry Function 205 of the GLOME 3007. This query and response can be performed using the Application Gateway Control Protocol 206 function in the GLOME 3007. The GLOME 3007 will then store the Message Records 906 for the POD 3008 in the Message Mapping Table 203 as a Message Record 2400 and the Authentication Key 402 in the GLOME's Local Virtual Registry 205. A similar process may be required in GLOME 3001.

User to POD Interaction

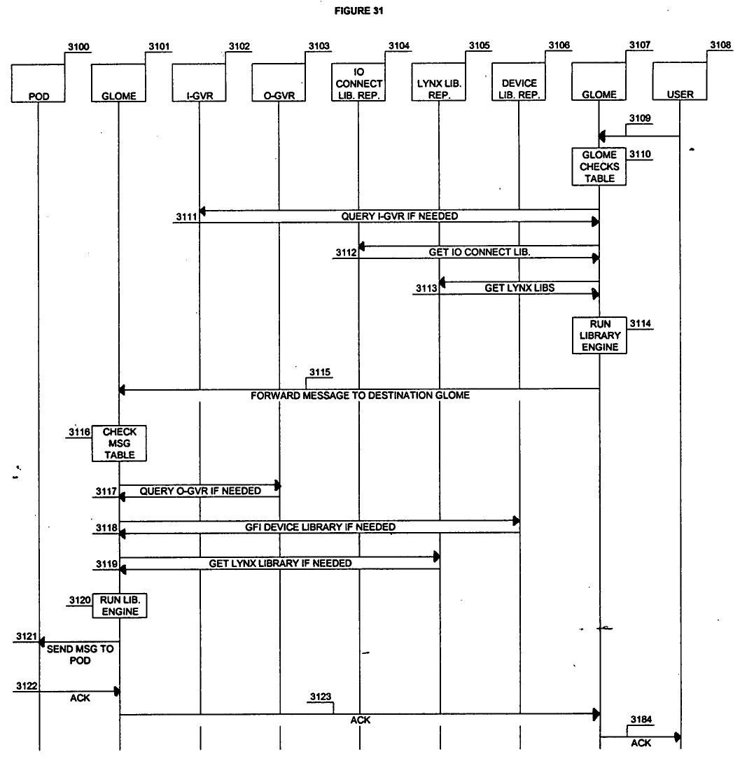

FIG. 31 is a data flow diagram illustrating one embodiment of a method of communication between a User 3108 and a POD 3100. After a user 3108 has been authenticated as described above in the IOS User Interaction description, the user 3108 may send a message to the GLOME 3107 in a step 3109. The message will contain the User's user Id 701 and a Message Number 2401 and potentially additional parameters.

Upon receipt of the message at the GLOME 3107, the user ID is used to look up the MSG User Record 2202 in the Message Mapping Table 203 using the User Identifier 701 in a step 3110. The message may be encrypted and will then be de-encrypted using the Authentication Function 209 and the User Identifier 701 and User Password 702 for the User that is stored in the Local Virtual Registry Function 205 of the GLOME 3107. The GLOME 3107 then searches the MSG User Record 2202 for the Message Record 2303 using the Message Number 2401 specified in the message from the user.

The Message Record 2303 identifies one or more Library IDs 2402, 2403 which correspond to the libraries needed to process the parameters passed by the user. In one embodiment, the order of the Library IDs 2402, 2403 in the message record 2303 specifies the order that the libraries are placed in the GLOME Library Sockets 201 for use by the library engine 202. The libraries may be IoConnect libraries or lynx libraries, for example. In this example, the Destination User ID 2405 is empty and the Destination POD ID 2404 designates the POD 3100 for receipt of information in response to the user initiated event. The GLOME 3107 checks its Library Cache 204 to see if the IoConnect libraries specified by the Library Ids 2402 are there. If not, the GLOME 3107 retrieves the library specified by the Library IDs 2402 using the Application Query Language function 207 in a step 3112. In one embodiment, Application Query Language is the same as SQL except it is optimized for retrieving execution logic (libraries). The GLOME 3107 also checks if the Lynx Library identified by Library ID 2403 is stored in the GLOME 3107 Library Cache 204 and retrieves the Lynx Library from the Lynx Library repository 3105, 111 in a step 3113 if not in the cache 204. Since all Library IDs are unique, the Library IDs 2403 specify the Library Required.

Once the GLOME 3107 has retrieved all of the libraries, the Library Engine 202 executes the libraries using the parameters passed Message from the user and communicates the result in a result message 3700 to one or more destination GLOMEs 3101, in a step 3115 as specified in the Destination POD ID field 2404 of the MSG Record 2400. The Result Message 3700 will contain the Destination GLOME Identifier 3701 and the Individual POD Identifier 401 of the Destination POD. The Message Class Field 3704 contains the Output Class 1803 specified by the last Lynx Library 2403 in the MSG Record 2303.

The GLOME 3107 removes the libraries from the Library Engine 202 following execution, but continues to store the libraries and the authentication key 402 in its Library Cache 204 for later use until a specified time or until the library is explicitly removed. Since the Result Message 3700 is destined for a POD from the IOS, the Destination GLOME 3101 checks the IOS POD Record 2203 in its Message Mapping Table 203 in a step 3116 for the POD Identifier 401 specified in the Result Message 3700. When the IOS POD Record 2203 is found, the GLOME 3101 searches for the record with the MSG Class 4102 as described in FIG. 43. This record will contains one or more Library ID's 906, 906 (FIG. 41) designating the Device or Lynx libraries for execution at the Destination GLOME's 3101 Library Engine 202. The GLOME 3101 may need to fetch the Libraries from the Device Library Repository 112, 3106 in a step 3118. The GLOME 3101 may also determine whether additional data is required from other triggering devices or users that it must wait for prior to executing libraries designated in the IOS User Record 2204 based on the logic in the Libraries listed 906.

Once all of the triggers have occurred and the Libraries are retrieved (if not cached), the libraries are executed on the Library Engine 202 at the GLOME 3101 in a step 3120. The message generated in response to the execution of the libraries is communicated to the POD 3100 in a step 3121 using the destination POD Identifier 401 specified in the Result Message 3700, and the receipt of the message is acknowledged to the GLOME 3101 in a step 3122. The acknowledgment is communicated to the GLOME 3107 in a step 3123, and to the user 3108 in a step 3124.

If GLOME 3107 does not have a record in the Message Mapping Table 203, the GLOME 3107 uses the User Identifier 701 contained in the message from the user to Query 3111 the 1-GVR 3102 associated with the user 3108. The I-GVR will download the I-GVR record 602 for the user 3108 to the GLOME 3107 where it will be placed in the Local Virtual Registry Function 205 of the GLOME 3107. This query and response can be performed using the Application Gateway Control Protocol 206 function in the GLOME 3107. The GLOME 3107 will then store the Message Records 906 for the user 3108 in the Message Mapping Table 203 as a Message Record 2400 and the User Password 702 in the GLOME's Local Virtual Registry 205.

If GLOME 3101 does not have a record in the Message Mapping Table 203, the GLOME 3101 uses the POD Identifier 401 contained in the Result Message 3700 to Query 3117 the O-GVR 3103 associated with the POD 3100. The O-GVR will download the O-GVR record 900 for the POD 3100 to the GLOME 3101 where it will be placed in the Local Virtual Registry Function 205 of the GLOME 3101. This query and response can be performed using the Application Gateway Control Protocol 206 function in the GLOME 3101. The GLOME 3101 will then store the Message Records 906 for the POD 3001 in the Message Mapping Table 203 as a Message Record 2400 and the Authentication Key 402 in the GLOME's Local Virtual Registry 205.

One POD to Many POD Interaction

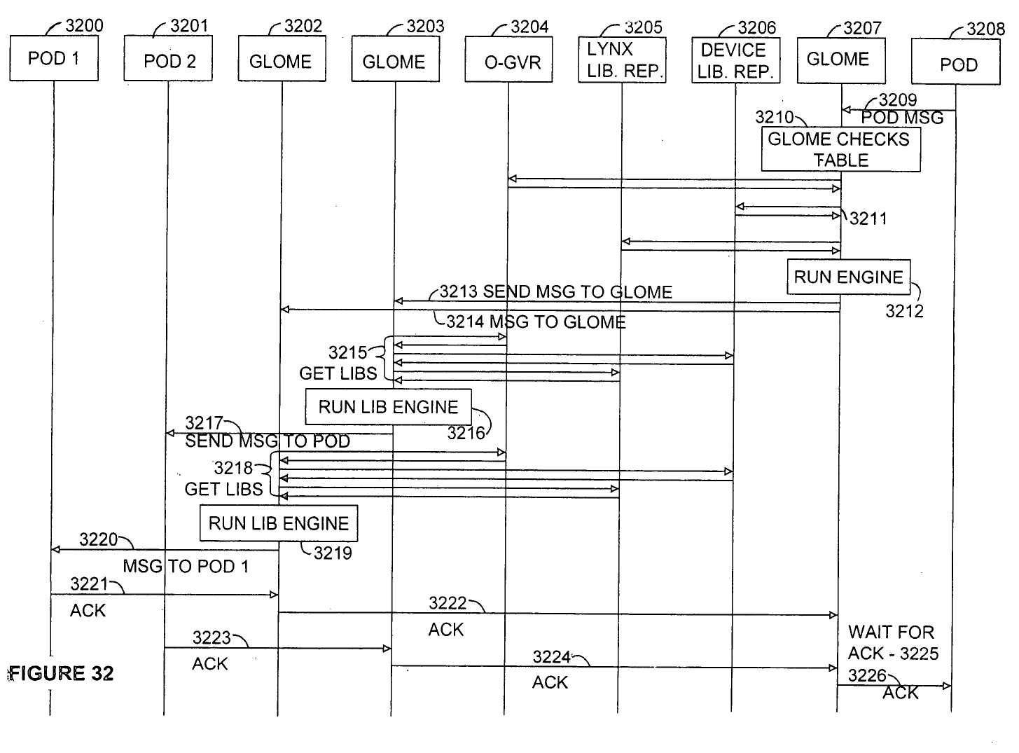

FIG. 32 is a data flow diagram illustrating one embodiment of a method of communication between one POD 3208 and two other PODs 3200, 3201. Following download of a POD trigger rule via a WCP Trigger Message 3800 as described above, a POD 3208 waits until the trigger event occurs at the device. When the trigger event occurs as detected by the POD 3208, the POD 3208 sends a WCP Message 4000, with its MSG Type field 4002 set to “WCP Data Message Type”, to the GLOME 3207 specified in the PODs GLOME Attachment Address Field 407 in a step 3209. The WCP Message 4000 comprises the WCP Data Message 2600 in its Payload 4004. The WCP message 4000 is preferably encrypted using the POD Authentication Key 402. Additional Encryption information, including an unencrypted copy of the POD Identifier, a temporary POD Identifier, or a RAND Key may be sent in the Encryption Information field 4003 in an unencrypted format. The WCP Data Message 2600 comprises the POD Identifier 401 of the POD 3208 in the POD Identifier field 401. The message number assigned to the specific trigger event is placed in the Message Number Field 2401. If more than one interaction is mapped to the specific trigger, additional Message Number Fields 2401 are included for each interaction. Each Message Number Field 2401 includes a set of parameters 2603, associated with it that were defined by the POD Trigger rule.

Upon receipt of the WCP Message 4000 at the GLOME 3207, the unencrypted POD Identifier 401 (or Temporary POD Identifier) in the Encryption Information Field 4003 is used to look up the MSG POD Record 2300 in the Message Mapping Table 203 using the POD Identifier 401 in a step 3210. If the message had come from an Individual User or External application Program, the GLOME 3207 would search the MSG User Records 2202 in the message mapping table 203. If the POD 3208 has a record 2300 in the Message Mapping Table 203, the WCP Message 4000 is de-encrypted using the Authentication Function 209 and the Authentication Key 402 for the POD 3208 that is stored in the Local Virtual Registry Function 205 of the GLOME 3207. The GLOME 3207 then searches the MSG POD Record 2300 for the Message Record 2303 using the Message Number 2401 specified in the Message Number Field of the WCP data message 2600.

The Message Record 2303 identifies one or more Libraries IDs 2402, 2403 which correspond to the Libraries needed to process the WCP data message 2600. In this case, the Message Record 2303 has two records for the same Message Number 2401 meaning that there are two receivers for this message number. The GLOME 3207 must process the parameters 2603 in passed in the WCP Data Message 2600 in a step 3212 for both records using the Library IDs 2401 and Destination POD ID 2404 in each record individually.

If the GLOME 3207 needs to query the O-GVR or get libraries as described in the examples above for each of the destination GLOMEs, it does this in a step 3211.

Once the GLOME 3207 has retrieved all of the libraries, the Library Engine 202 executes the libraries specified in the first entry of the MSG Record 2400 using the parameters 2603 passed in the WCP Data Message 2600 in a the step 3212 and communicates the result in a result message 3700 to the destination GLOME 3203, as specified in the Destination POD ID field 2404 of the first entry of the MSG Record 2400 in a step 3313. The Result Message 3700 will contain the Destination GLOME Identifier 3203 and the Individual POD Identifier 401 of the Destination POD 3202. The Message Class Field 3704 contains the Output Class 1803 specified by the last Lynx Library 2403 in the MSG Record 2303.

The Library Engine 202 next executes the libraries specified in the second entry of the MSG Record 2400 using the parameters 2603 passed in the WCP Data Message 2600 in a the step 3212 and communicates the result in a result message 3700 to the destination GLOME 3202, as specified in the Destination POD ID field 2404 of the second entry of the MSG Record 2400 in a step 3314. The Result Message 3700 will contain the Destination GLOME Identifier 3203 and the Individual POD Identifier 401 of the Destination POD 3202. The Message Class Field 3704 contains the Output Class 1803 specified by the last Lynx Library 2403 in the MSG Record 2303.

The GLOME 3007 removes the libraries from the Library Engine 202 following execution, but continues to store the libraries and the authentication key 402 in its Library Cache 204 for later use until a specified time or until the library is explicitly removed.

The GLOME 3203 will process the 3700 message delivered in step 3213 in the normal fashion by checking its message mapping table 203, getting the libraries if needed in a step 3315, running the library logic on the Library Engine is a step 3216, and delivering the message to the destination POD 3201 in a step 3217. The POD 3201 will acknowledge to the GLOME 3203 in a step 3223 and the GLOME 3203 will pass an acknowledgement to the GLOME 3207. Since the GLOME 3207 remembers that there was more than Result Message 3700 sent out for this transaction, it will wait for an acknowledgement from GLOME 3203 before sending an acknowledgement to POD 3208.

The GLOME 3201 will process the 3700 message deliverd in step 3214 in the normal fashion by checking its message mapping table 203, getting the libraries if needed in a step 3218, running the library logic on the Library Engine is a step 3219, and delivering the message to the destination POD 3200 in a step 3220. The POD 3200 will acknowledge to the GLOME 3202 in a step 3221 and the GLOME 3202 will pass an acknowledgement to the GLOME 3207. Since the GLOME 3207 remembers that there was more than Result Message 3700 sent out for this transaction, it has been waiting for the acknowledgement. It can now send an acknowledgement to POD 3208 in a step 3226.

Many PODs to One POD Interaction with Waiting

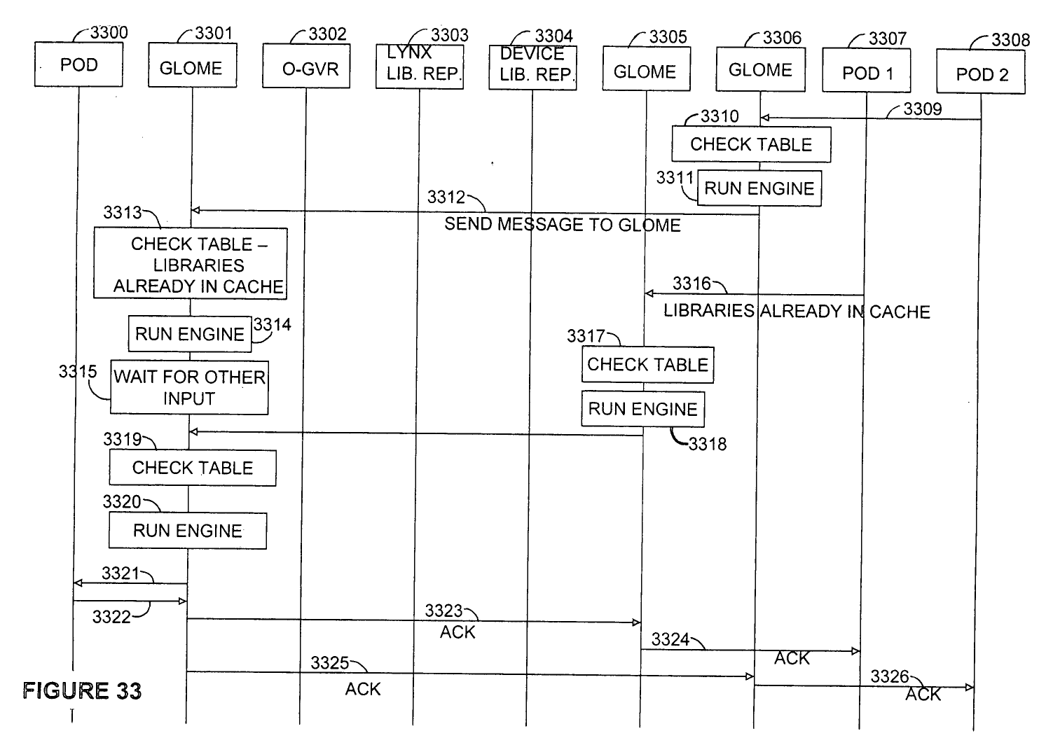

FIG. 33 is a data flow diagram illustrating one embodiment of a method of communication two PODs 3307, 3308 and a single POD 3300 highlighting the IOS capability to wait for all inputs before finishing a transaction 3315. This capability is implemented in the Lynx Library at the Destination GLOME 3301.

The POD 3308 sends a WCP message to the GLOME 3306 when a trigger occurs as described above. The GLOME 3306 checks its Message Mapping Table in a step 3310 and runs its library engine on the resulting libraries in a step 3311 as described previously. It is assumed that the proper libraries are already in its Library Cache 204. It then forwards a Result Message 3700 to the Destination GLOME 3301 in the standard way. The GLOME 3301 checks its Message Mapping table on the incoming message in a step 3313, and runs its library engine in a step 3314. In this case the logic of one of the libraries specifies another input result must be received before execution can proceed, so the GLOME 3301 waits for further inputs in a step 3315. The library specifies the Result Message(s) 3700 that are required before it can proceed. Since Result Messages contain the POD Identifier 401 or User Identifier 701 of the Destination as well as the Message Class 4102, the GLOME 3301 knows which messages to wait for.

Soon the POD 3307 sends a WCP message to the GLOME 3305 when a trigger occurs as described above. The GLOME 3305 checks its Message Mapping Table in a step 3317 and runs its library engine on the resulting libraries in a step 3318 as described previously. It is assumed that the proper libraries are already in its Library Cache 204. It then forwards a Result Message 3700 to the Destination GLOME 3301 in the standard way. The GLOME 3301 checks its Message Mapping table on the incoming message in a step 3319 and realizes that it is waiting for this message to complete a previously initiated transaction. The GLOME now runs its library engine in a step 3320 using the parameters from both messages as inputs and sends the result to the POD 3300. The POD 3300 acknowledges in a step 3322 and the GLOME 3301 sends acknowledge messages to both GLOMEs 3305 and 3306 in steps 3323 and 3325 respectively. The GLOMEs 3307 and 3308 send acknowledgements to their respective PODs in steps 3324 and 3326.

1. A wide area network for connecting and controlling a plurality of devices, comprising:
a plurality of devices, wherein each device has a unique identifier;
at least one edge server configured to communicate with at least one of said plurality of devices and receive said unique identifier; and
at least one first virtual registry in communication with said at least one edge server and configured to associate said unique identifier with at least one server, wherein said at least one server stores an instruction file configured for execution on said edge server, wherein execution of said instruction file enables the edge server to control the device.

2. The wide area network of claim 1, wherein said at least one edge server is configured to communicate with said plurality of devices over at least one of a wireless network, a cable network, the Internet, and a local area network.

3. The wide area network of claim 1, further comprising a second virtual registry in communication with said at least one edge server and configured to store user information, said at least one unique identifier, and one or more device rules in connection with said at least one unique identifier, and wherein said at least one edge server is configured to control said device according to said device rules.

4. The wide area network of claim 1, wherein said at least one edge server is configured to encrypt communications with said devices.

5. The wide area network of claim 1, wherein said at least one edge server acts as a gateway into a trusted domain.

6. The wide area network of claim 1, further comprising an object browser configured to create said instruction file.

7. The wide area network of claim 6, wherein said object browser displays icons representing said plurality of devices.

8. The wide area network of claim 7, wherein selecting one of said icons representing one of said devices on said object browser results in the display of graphical representations of sub-components of said device being represented.

9. A method of controlling a plurality of devices in a wide area network, comprising:
providing a plurality of devices, wherein each device has a unique identifier;
transmitting said unique identifier to an edge server, wherein said edge server is configured to transmit said unique identifier to a virtual registry;
determining at least one server comprising an instruction file by using said virtual registry to associate said unique identifier with said server; and
transmitting said instruction file to said edge server, wherein said edge server is configured to execute said instruction file and thereby control functions of said device.

10. The method of claim 9, wherein said edge server is configured to encrypt communications with said devices.

11. The method of claim 9, wherein said one edge server acts as a gateway into a trusted domain.

12. The method of claim 9, further comprising displaying an object browser to a user, wherein said object browser is configured to create said instruction file.

13. The method of claim 12, wherein said object browser displays icons representing said plurality of devices.

14. The method of claim 13, wherein selecting one of said icons representing one of said devices on said object browser results in the display of graphical representations of sub-components of said device being represented.

15. A system for controlling a plurality of devices in a wide area network, comprising:
means for providing a plurality of devices, wherein each device has a unique identifier;
means for transmitting said unique identifier to an edge server, wherein said edge server is configured to transmit said unique identifier to a virtual registry;
means for determining at least one server comprising an instruction file by using said virtual registry to associate said unique identifier with said server; and
means for transmitting said instruction file to said edge server, wherein said edge server is configured to execute said instruction file and thereby control functions of said device.

16. The system of claim 15, wherein said edge server is configured to encrypt communications with said devices.

17. The system of claim 15, wherein said one edge server acts as a gateway into a trusted domain.

18. The system of claim 15, further comprising means for displaying an object browser to a user, wherein said object browser is configured to create said instruction file.

19. The system of claim 18, wherein said object browser displays icons representing said plurality of devices.

20. The system of claim 19, wherein selecting one of said icons representing one of said devices on said object browser results in the display of graphical representations of sub-components of said device being represented.
